(19) United States
(12) Patent Application Publication
(10) Pub. No.: US 2025/0217170 A1
(43) Pub. Date: Jul. 3, 2025

(54) Machine-Learned User Interface Command Generator Using Pretrained Image Processing Model

(71) Applicant: Google LLC, Mountain View, CA (US)

(72) Inventors: Peter Thomas Shaw, Seattle, WA (US); Mandar Joshi, Seattle, WA (US); Kristina Nikolova Toutanova, Redmond, WA (US); James Fischl Cohan, New York, NY (US); Jonathan Haim Berant, Seattle, WA (US); Kenton Chiu Tsun Lee, Kirkland, WA (US); Panupong Pasupat, Sunnyvale, CA (US); Hexiang Hu, Los Angeles, CA (US); Urvashi Khandelwal, Los Altos, CA (US)

(21) Appl. No.: 19/002,441

(22) Filed: Dec. 26, 2024

Related U.S. Application Data
(60) Provisional application No. 63/615,607, filed on Dec. 28, 2023.

(51) Int. Cl. G06F 9/451; G06F 9/54; G06V 30/19

(52) U.S. Cl. CPC G06F 9/451; G06F 9/54; G06V 30/19

(57) ABSTRACT

An example method can include providing a natural language instruction and user interface image data to a machine-learned sequence processing model that is configured to process image data and generate commands for controlling the target computing device, wherein the machine-learned sequence processing model has parameters learned using an interface recognition objective based on an evaluation of an interface recognition output generated based on processing a rendered training interface from a pre-training dataset and an interface navigation objective based on an evaluation of a user interface command generated based on processing a rendered training interface from a fine-tuning dataset; receiving, from the machine-learned sequence processing model, a command indicating an interaction with the user interface to implement the natural language instruction; and generating, based on the command, a control signal configured to initiate the interaction.

### PRIORITY CLAIM

The present application claims priority to U.S. Provisional Application No. 63/615,607 filed Dec. 28, 2023, which is hereby incorporated by reference herein in its entirety.

### FIELD

The present disclosure relates generally to machine learning processes and machine-learned devices and systems. More particularly, the present disclosure relates to using pixel-based pretraining to obtain machine-learned models that can control user interface elements, as well as fine-tuning approaches for the same.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example computing system. The example computing system can include one or more processors and one or more non-transitory computer-readable media storing instructions that are executable by the one or more processors to cause the example computing system to perform example operations. The example operations can include obtaining a natural language instruction. The example operations can include obtaining user interface image data describing a state of a user interface of a target computing device. The example operations can include providing the natural language instruction and the user interface image data to a machine-learned sequence processing model that is configured to process image data and generate commands for controlling the target computing device. In the example computing system, the machine-learned sequence processing model comprises parameters that were learned using an interface recognition objective based on an evaluation of an interface recognition output generated based on processing a rendered training interface from a pre-training dataset. In the example computing system, the machine-learned sequence processing model comprises parameters that were learned using an interface navigation objective based on an evaluation of a user interface command generated based on processing a rendered training interface from a fine-tuning dataset. The example operations can include receiving, from the machine-learned sequence processing model, a command indicating an interaction with the user interface to implement the natural language instruction. The example operations can include generating, based on the command, a control signal configured to initiate the interaction.

In some implementations of the example computing system, the natural language instruction is rendered into instruction image data that is combined with the user interface image data for input to the machine-learned sequence processing model.

In some implementations of the example computing system, the machine-learned sequence processing model is unimodal.

In some implementations of the example computing system, the machine-learned sequence processing model comprises parameters that were learned using a text recognition objective based on an evaluation of textual content recovered from an image of a text snippet.

In some implementations of the example computing system, the machine-learned sequence processing model comprises parameters that were learned by training an initialized machine-learned sequence processing model using the text recognition objective to obtain a first model checkpoint; training the first model checkpoint using the interface recognition objective to obtain a second model checkpoint; and training the second model checkpoint using the interface navigation objective to obtain a third model checkpoint.

In some implementations of the example computing system, the machine-learned sequence processing model comprises an image encoder and a text decoder.

In some implementations of the example computing system, the machine-learned sequence processing model comprises a natural language encoder that processes a textual input to encode the natural language instruction into a first latent representation; an image encoder that processes the user interface image data to encode the user interface image data into a second latent representation; and a text decoder that processes the first latent representation and the second latent representation to generate commands. In some implementations of the example computing system, the text decoder is configured with a natural language output vocabulary.

In some implementations of the example computing system, generating the control signal comprises inputting the command to an interpreter, wherein the interpreter receives the command and executes a control script to implement the command. In some implementations of the example computing system, the interpreter maps commands to control functions associated with an operating environment of the target computing device. In some implementations of the example computing system, the interpreter comprises a machine-learned classifier that processes the commands and identifies the control functions that are predicted to correspond to the commands. In some implementations of the example computing system, the interpreter comprises deterministic logic that processes the commands and identifies the control functions that are defined to correspond to the commands.

In some implementations of the example computing system, the command comprises at least: a selection command; a cursor movement command; a keypress command; or a scroll command.

In some implementations of the example computing system, the command comprises an input to an application programming interface that invokes an operation of an application operating on the target computing device.

In some implementations of the example computing system, the example computing system includes a controller computing device that comprises the one or more processors and the one or more non-transitory computer-readable media. In some implementations of the example computing system, the example computing system includes the target computing device, and the target computing device comprises the one or more processors and the one or more non-transitory computer-readable media.

In some implementations of the example computing system, the one or more non-transitory computer-readable media store a client application and an application programming interface (API). The API can be configured to receive input image data and input natural language instruction data describing an action to perform using an user interface described by the input image data; and return an output command for execution by the computing system to interact with the user interface described by the input image data. In some implementations of the example computing system, the one or more non-transitory computer-readable media store the machine-learned sequence processing model, and the machine-learned sequence processing model is configured to process image data received via the API and generate commands for output via the API; and

In some implementations of the example computing system, the example operations comprise: inputting, to the API, image data; and receiving, from the API, the command.

In an aspect, example implementations of the present disclosure provide one or more example non-transitory computer-readable media storing instructions that are executable by one or more processors to cause a computing system to perform example operations. The example operations can include obtaining a natural language instruction. The example operations can include obtaining user interface image data describing a state of a user interface of a target computing device. The example operations can include providing the natural language instruction and the user interface image data to a machine-learned sequence processing model that is configured to process image data and generate commands for controlling the target computing device. The machine-learned sequence processing model can include parameters that were learned using an interface recognition objective based on an evaluation of an interface recognition output generated based on processing a rendered training interface from a pre-training dataset; and an interface navigation objective based on an evaluation of a user interface command generated based on processing a rendered training interface from a fine-tuning dataset. The example operations can include receiving, from the machine-learned sequence processing model, a command indicating an interaction with the user interface to implement the natural language instruction. The example operations can include generating, based on the command, a control signal configured to initiate the interaction.

In an aspect, example implementations of the present disclosure provide an example method for training a machine-learned sequence processing model to predict actions that traverse one or more states in a user interface navigation graph for a user interface. The example method can include forking at least a portion of a pre-trained machine-learned user interface processing model to obtain a policy network and a value network that are both initialized based on the pre-trained machine-learned user interface processing model. The example method can include fine-tuning the policy network using an action prediction objective based on an evaluation of an action predicted by the policy network for a corresponding state. The example method can include fine-tuning the value network using a value prediction objective based on an evaluation of an accumulated reward that is predicted by the value network for an input state. The example method can include traversing, for a plurality of iterations, the user interface navigation graph by, for a given input state of the user interface. The example method can include selecting a next action based on an estimated value of the input state, wherein the estimated value comprises a first component predicted by the value network and a second component comprising a measured accumulated reward obtained based on one or more rollouts using the policy network to select actions at the given input state and one or more subsequent states. The example method can include updating the policy network to increase a likelihood of an action that was most often selected as the next action for the given input state across the plurality of iterations.

In some implementations of the example method, fine-tuning the policy network comprises fine-tuning a policy fork of a text decoder of the pre-trained machine-learned sequence processing model to generate textual commands; and fine-tuning the value network comprises fine-tuning a value fork of the text decoder of the pre-trained machine-learned sequence processing model to output textual value indicators.

In an aspect, example implementations of the present disclosure provide computing systems and non-transitory computer-readable media configured to implement the example method.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example implementations of aspects of the present disclosure.

FIG. 2 is a block diagram of an example system according to example implementations of aspects of the present disclosure.

FIG. 3 is a block diagram of an example system according to example implementations of aspects of the present disclosure.

FIG. 4 is an illustration of an example system processing an example state of a user interface according to example implementations of aspects of the present disclosure.

FIG. 5 is an illustration of an example system processing an example state of a user interface according to example implementations of aspects of the present disclosure.

FIG. 6 is an illustration of an example system processing an example state of a user interface according to example implementations of aspects of the present disclosure.

FIG. 7 is an illustration of an example system processing an example state of a user interface according to example implementations of aspects of the present disclosure.

FIG. 8 is an illustration of an example system processing an example state of a user interface according to example implementations of aspects of the present disclosure.

FIG. 9 is an illustration of an example system processing an example state of a user interface according to example implementations of aspects of the present disclosure.

FIG. 10 is a block diagram of an example system according to example implementations of aspects of the present disclosure.

FIG. 11 is a graph diagram illustrating a training technique according to example implementations of aspects of the present disclosure.

FIG. 12 is a block diagram illustrating a training technique according to example implementations of aspects of the present disclosure.

FIG. 13 is a chart showing example test results of a test implementation according to example implementations of aspects of the present disclosure.

FIG. 14 is a flow chart diagram illustrating an example method for implementations according to example implementations of aspects of the present disclosure.

FIG. 15 is a flow chart diagram illustrating an example method for implementations according to example implementations of aspects of the present disclosure.

FIG. 16 is a flow chart diagram illustrating an example method for training a machine-learned model according to example implementations of aspects of the present disclosure.

FIG. 17 is a block diagram of an example processing flow for using machine-learned model(s) to process input(s) to generate output(s) according to example implementations of aspects of the present disclosure.

FIG. 18 is a block diagram of an example sequence processing model according to example implementations of aspects of the present disclosure.

FIG. 19 is a block diagram of an example technique for populating an example input sequence for processing by a sequence processing model according to example implementations of aspects of the present disclosure.

FIG. 20 is a block diagram of an example model development platform according to example implementations of aspects of the present disclosure.

FIG. 21 is a block diagram of an example training workflow for training a machine-learned model according to example implementations of aspects of the present disclosure.

FIG. 22 is a block diagram of an inference system for operating one or more machine-learned model(s) to perform inference according to example implementations of aspects of the present disclosure.

FIG. 23 is a block diagram of an example networked computing system according to example implementations of aspects of the present disclosure.

FIG. 24 is a block diagram of an example computing device according to example implementations of aspects of the present disclosure.

FIG. 25 is a block diagram of an example computing device according to example implementations of aspects of the present disclosure.

### DETAILED DESCRIPTION

Generally, the present disclosure is directed to machine-learned models and machine-learning techniques that can interact with graphical user interfaces (GUIs) to perform tasks. Example implementations provide for systems that can interact with GUIs using the same modalities as human users: the system can process a rendering of the GUI and output system-level input commands (e.g., taps, clicks, etc.). This can enable automated interactions with substantially any GUI, without requiring custom application programming interfaces for each application. An example system can ingest a natural language instruction and an image-based rendering of a GUI and generate a command for following instruction.

Example systems according to the present disclosure can follow instructions to automatically perform actions using GUIs without expensive customization or adaptation. This can help automate tedious tasks, improve accessibility, and expand the usefulness of digital assistants by allowing them to interact with tools and services without requiring modifications to those tools and services or customization of the assistant to each tool or service.

Despite the visual nature of GUIs, many existing approaches have primarily relied on system-level information that would not ordinarily be exposed to a user (and thus require separate interaction workflows). For instance, many prior approaches rely on ingesting structured representations of the user interfaces (such as HTML sources, Document Object Model (DOM) trees, and Android view hierarchies, etc.) as well as custom, task-specific representations of high-level actions based on these structured representations. While these approaches have provided good performance on specific tasks in controlled environments, structured and task-specific representations are not always available. For instance, some web applications use extensive scripting that may be hidden from a client endpoint. Sandboxed environments can restrict access to DOM information. And mobile applications often do not expose the underlying structure to external modules. Even when structured application source data is available, it can be hard to interpret due to obfuscation and misalignment with what actually appears on the GUIs.

In contrast, example implementations of the present disclosure achieve SOTA performance navigating GUIs using only reliably available information: graphical information. GUIs generally convey sufficient information graphically to enable human users to perceive the visual input and provide generic system-level inputs (e.g., taps, clicks, keypresses, etc.), without needing to inspect the application's source code for cues on its functionality. Advantageously, using only the graphical information exposed to users in the normal course of interface operation, example models and systems introduced herein can provide GUI navigation performance that meets or even exceeds typical human performance.

Example implementations provide solutions to several challenges in learning from pixel-only inputs coupled with general system-level actions. For instance, interpreting GUIs visually can involve understanding the interface layout, recognizing and interpreting visually-situated natural language, identifying visual elements, and predicting their functions and methods of interaction. A generic action space also poses the challenge of a more complex mapping between high-level textual instructions and corresponding sequences of low-level actions. As an example of the increased difficulty in this setting, on the MiniWob++ benchmark of web GUI interaction, introduced by Liu et al., Reinforcement learning on web interfaces using workflow-guided exploration, Arxiv (Feb. 24, 2018), https://arxiv.org/abs/1802.08802, based on Shi et al., World of bits: An open-domain platform for web-based agents, in International Conference on Machine Learning, 70 PROC. OF MACHINE LEARNING RES. 3135 (August 2017), one prior approach demonstrates human-level accuracy when accessing both screenshots and DOM structure, but its performance drops by 75% when the DOM information is removed from the agent's observations. See Humphreys et al., A data-driven approach for learning to control computers, in International Conference on Machine Learning, in PROC. OF MACHINE LEARNING RES. 9466 (2022).

By applying navigation-based fine-tuning to an image processing model that has been pre-trained to understand GUI architecture, example implementations of the present disclosure can implicitly leverage such structural knowledge of GUIs when performing GUI navigation tasks. For instance, example image processing models can be trained to process image data depicting a GUI and output a prediction of a structured representation of the GUI (e.g., HTML or other markup, an outline structure, etc.). Such models can thus learn an understanding of GUI architecture that enables the models to infer a structure from a rendering of the GUI. By using the learned parameters of this pre-trained model as a starting point for learning the navigation task, example implementations of the present disclosure advantageously overcome the dependence of prior approaches on access to explicit structural representations.

In an example, the pre-trained image processing model can include an image encoder and a text decoder. The image encoder can be configured to ingest an input rendering of a GUI, and the text decoder can be configured to output a textual structured description of the GUI. During fine-tuning for navigation tasks, the image processing model can be trained to ingest an input rendering of a GUI and a natural language instruction and decode textual commands for interacting with the GUI. The natural language instruction can be input via a new input encoder or can be rendered into image data for processing alongside the input rendering of the GUI. In this manner, for instance, by processing a single image-based modality, example implementations can retain more components from the pretrained model and increase knowledge transfer from the pre-trained model weights.

Further, the text decoder can be retrained to output textual commands instead of textual structures describing the GUI. By decoding output commands in a natural language output space, expanding or shifting the output command set can still leverage the implicit understanding of GUI architectures in the learned parameters. Adding or replacing layers can be avoided in some instances, avoiding randomly initialized parameters when appropriate.

Example aspects of the present disclosure can provide a number of technical effects and benefits. For instance, techniques according to the present disclosure can provide for implementations of automated GUI navigation systems that can eliminate the need for custom interface tuning or API access, providing significant advantages over existing systems. Example implementations can greatly simplify the integration process, enabling seamless navigation across a wide range of applications without the need for any code modifications or API integrations. This in turn can significantly reduce the time and effort required for deployment and updates, allowing users to leverage the automated navigation capabilities quickly and efficiently.

Example implementations can also dynamically adapt to changes in the user interface, providing improved versatility over prior approaches. Unlike systems that rely on predefined rules or require manual updates, example implementations can automatically adjust to UI changes, providing uninterrupted navigation functionality even when the host applications undergo updates or modifications. This can reduce or eliminate the need for constant maintenance or reconfiguration, saving valuable time and resources.

To illustrate these advantages, consider the following examples. A user device (e.g., a mobile phone, etc.) can have limited input interface functionality. For instance, a touchscreen can be small, such that fine selections or inputs can be challenging to initiate for many users. An example user interface command generator according to the present disclosure can assist users in interacting with their devices. For example, a user can speak into a microphone of the device. The device can recognize the speech and transcribe the natural language content of the speech. The user can verbally instruct the device to perform an action, and an example user interface command generator according to the present disclosure can obtain a rendering of a current state of the user interface (e.g., a screenshot) and process the rendering in view of the natural language instruction to accomplish the requested action.

While some traditional digital assistants can perform actions responsive to verbal requests, such actions are generally limited to select or preconfigured environments, such as native applications of an operating system that have been hand-crafted to provide background access to a digital assistant.

Advantageously, the example user interface command generator according to the present disclosure can perform actions across environments, even new applications that have not previously been onboarded. For example, the user can interact with a shopping web application. The web application can be hosted by a third party that has not exposed any API for interactions from an assistant component. The user can instruct the device with a natural language instruction such as “add the red sweater to my cart.” Even without background integration with the web-based application, the example user interface command generator according to the present disclosure can capture a screenshot of the web-based application interface and process the screenshot to identify a next action to perform to accomplish the requested task. A next action can include clicking on a color selection button to cause the displayed sweater to update from a blue sweater to a red sweater. The example user interface command generator can generate a selection command at screen coordinates corresponding to the color selection button. The example user interface command generator can execute the command (e.g., using a control interface of the device, such as a system-level input API exposed by the operating system of the device) to select the red sweater.

After a first interaction with the GUI, the example user interface command generator can obtain a new screenshot reflecting an updated state of the web application. The updated state of the web application can represent selection of the red sweater. The example user interface command generator can determine a next action is to select an “Add to cart” button. The example user interface command generator can generate a selection command at screen coordinates corresponding to the “Add to cart” button. The example user interface command generator can execute the command to add the red sweater to the user's cart.

After this second interaction with the GUI, the example user interface command generator can obtain a new screenshot reflecting an updated state of the web application. The updated state of the web application can represent that the sweater is in the cart. The example user interface command generator can determine that the requested action has been performed.

Advantageously, the above example implementation can operate seamlessly as the web application is redesigned or reconfigured without requiring updates to or reconfiguration of the example user interface command generator. As such, example user interface command generators according to the present disclosure offer improved user interfaces that assist users in performing tasks using computing devices.

In another example, a user can be attempting to book a flight online using a travel website. The travel website can be a securely hosted website that does not enable external access to low-level interactions with site content. The user can instruct the device with a natural language instruction such as “Book a flight to New York on the 15th of next month.” The user interface command generator can capture a screenshot of the travel website interface and process the screenshot to identify a next action to perform to accomplish the requested task. A next action can include selecting the “Flights” tab. The user interface command generator can generate a selection command at screen coordinates corresponding to this tab and execute the command. After this interaction with the GUI, the user interface command generator can obtain a new screenshot reflecting an updated state of the travel website, and iteratively determine the next action to be performed until the flight is successfully booked. For instance, future actions can include filling in the destination as “New York” and selecting the date as “15th” of the next month. The user interface command generator can generate a selection command at screen coordinates corresponding to these options and execute the commands. After each interaction with the GUI, the user interface command generator can obtain a new screenshot reflecting an updated state of the travel website and determine the next action to be performed until the flight is successfully booked.

In another example, a user can be attempting to order food using a delivery service via an application operating on-device. The application can be encrypted, sandboxed, or otherwise prevent or omit access that would allow inspection of low-level architecture or structural configurations of the application. The user can instruct the device with a natural language instruction such as “Order a large pepperoni pizza from Neighborhood Pizzeria.” The user interface command generator can capture a screenshot of the food delivery application interface and process the screenshot to identify a next action to perform to accomplish the requested task. A sequence of actions can include clicking on the search bar, typing in “Neighborhood Pizzeria,” selecting the restaurant from the search results, selecting “large pepperoni pizza” from the menu, and finally clicking on “Add to cart” and “Place order.” As described herein, the user interface command generator can iteratively obtain screenshots, generate commands corresponding to these actions, and execute the commands. After each interaction with the GUI, the user interface command generator can obtain a new screenshot reflecting an updated state of the food delivery application and determine the next action to be performed until the food order is successfully placed.

In another example, a use can be using a desktop computer and is interacting with a productivity software application such as a spreadsheet or a word processor. The user can issue a natural language instruction such as “insert a pie chart in cell B5.” A user interface command generator according to the present disclosure can capture a screenshot of the spreadsheet application interface and process the screenshot to identify the next action to perform to accomplish the requested task. A sequence of next actions can include clicking on the “Insert” menu, then selecting the “Chart” option, and finally choosing a pie chart from the list of available chart types. As described herein, the user interface command generator can iteratively obtain screenshots, generate commands corresponding to these actions, and execute the commands. After each interaction with the GUI, the user interface command generator can obtain a new screenshot reflecting an updated state of the application and determine the next action to be performed until the pie chart is inserted in cell B5.

In another example, a user can be interacting with a music streaming application on a tablet device. The user can issue a natural language instruction such as “play my favorite playlist.” Without having any pre-existing integration with the music streaming app, a user interface command generator according to the present disclosure can capture a screenshot of the music app interface, process the screenshot to identify the next action to perform to accomplish the requested task. A sequence of next actions can include clicking on the “Library” tab, then selecting the “Playlists” section, and finally selecting the user's favorite playlist. As described herein, the user interface command generator can iteratively obtain screenshots, generate commands corresponding to these actions, and execute the commands. After each interaction with the GUI, the user interface command generator can obtain a new screenshot reflecting an updated state of the application and determine the next action to be performed until the application is playing the user's favorite playlist.

Other sources of natural language instruction can similarly benefit from the technical capabilities of example implementations of the present disclosure. For instance, digital assistants (e.g., voice assistants, chatbots, or other machine-learned systems that provide interactive assistance functions) can be limited in their ability to interact with applications due to a lack of API access. These assistants traditionally interact with applications through APIs which allow them to send and receive data directly from the application. However, not all applications provide APIs, and even when they do, the APIs may not expose all the functionalities that the assistant needs to perform its tasks.

Example systems disclosed herein can provide a solution to this limitation by enabling digital assistants to interact with applications using the same modalities as human users: through the application's GUI. Digital assistants can issue natural language instructions of tasks to perform with an application or device, and example implementations of the present disclosure can implement the instruction. By processing a rendering of the GUI and outputting system-level input commands, example implementations of the present disclosure can effectively automate interactions with any GUI, without requiring API access.

For example, a voice assistant can use the system to interact with a flight booking application. A user can issue a voice command to the digital assistant, such as “book my trip to HQ next week.” The digital assistant can leverage available tools (e.g., API integration with a calendar application) and other context to identify one or more tasks to perform in relation to the user's instruction. The digital assistant can identify a location of “HQ” as in New York, such as by using a list of saved locations in the user's mapping application. The digital assistant can then generate a natural language instruction of “Book a flight to New York on the 15th of next month.”

As described above, a user interface command generator can operate to implement this natural language instruction using a travel booking website. The digital assistant can cause a browser application to navigate to the website. This can operate in the foreground (e.g., such that the website is displayed to a user on a display device) or in the background (e.g., the browser renders the website headlessly. The example user interface command generator can capture a screenshot (e.g., an actual screen capture of a state of the screen, or a rendering of the website that is directly rendered to an image file, even if operating headlessly) of the travel website interface and process the screenshot to identify a next action to perform to accomplish the requested task. A next action can include selecting the “Flights” tab. The user interface command generator can generate a selection command at screen coordinates corresponding to this tab and execute the command. After this interaction with the GUI, the user interface command generator can obtain a new screenshot reflecting an updated state of the travel website, and iteratively determine the next action to be performed until the flight is successfully booked. For instance, future actions can include filling in the destination as “New York” and selecting the date as “15th” of the next month. The user interface command generator can generate a selection command at screen coordinates corresponding to these options and execute the commands. After each interaction with the GUI, the user interface command generator can obtain a new screenshot reflecting an updated state of the travel website and determine the next action to be performed until the flight is successfully booked.

Example tasks can also include context data collection, such as for downstream tasks. For instance, if the user did not use a calendar application that exposed API access to the digital assistant, the digital assistant could instruct an example user interface command generator to open the user's calendar application, navigate to the upcoming week, and open the calendar entries. The digital assistant could then process screenshots of the opened calendar entries (directly by ingesting the image, or indirectly by preprocessing the image with OCR to extract text) to obtain context for the user's command. In this manner, for instance, automated systems can parse content (e.g., web content, application content) across different environments without relying on a complex array of different APIs for each environment.

The digital assistant can execute one or more subtasks in this manner. The assistant can then execute the subtasks using example user interface command generators according to the present disclosure.

In an example, a user can be interacting with a digital assistant. The user might want to use a home automation application to control various devices around the house, such as lights, thermostats, and security systems. The user can issue a natural language instruction to the digital assistant such as “turn off the living room lights.” The digital assistant itself may not itself have access to a tool API to itself issue a command to turn off the lights. For instance, different home automation systems can operate on different protocols that may not be compatible with each other. Without any API integration with the home automation app itself, the digital assistant can leverage an operating system integration to open the home automation app (e.g., to initiate execution of the app). The GUI of the application can be rendered to a display device or headlessly rendered to an image file or cache of image files. The digital assistant an issue a natural language command to a user interface command generator according to the present disclosure. The example command generator can capture a rendering of the home automation app interface, process the screenshot to identify the next action to perform to accomplish the requested task. A sequence of next actions can include navigating to the “Living Room” section and then clicking on the “Lights” button to turn the living room lights off. The user interface command generator can generate these selection commands at screen coordinates corresponding to each of these actions. The user interface command generator can execute these commands to turn off the living room lights. The digital assistant can close the home automation app.

In this manner, for instance, example implementations of the present disclosure can significantly expand the capabilities of digital assistants, enabling them to interact with a wide range of applications and perform a wide variety of tasks across diverse environments that were previously not interoperable. This can greatly enhance the utility and versatility of digital assistants, which in turn can multiply the functionality of the computing devices on which they operate.

Other example tasks can include debugging tasks or software testing/validation tasks in which an example implementation can step through standardized testing workflows to evaluate performance of a UI or a program via the UI.

In addition to digital assistance, robotic devices and systems can also implement example implementation of the present disclosure. For instance, an example system can enable a robot to interact with GUIs in a way that is not reliant on specific programming for each unique interaction. This can dramatically expands the robot's potential range of actions and its ability to interact with different systems, even those that have not been specifically designed for robot interaction.

An example technical effect and benefit of example aspects of the present disclosure includes an improved ability to leverage smaller command generation models that can execute using less compute resources (e.g., less memory, fewer FLOPS, etc.). For example, by careful selection of a pre-trained image processing model that implicitly understands UI structures, a fine-tuned model can be obtained that can understand and respond to UI states without needing to explicitly regress representations of the UI structure. In this manner, for instance, the command generation model can be smaller. By fine-tuning for the command generation task, the model can be performant even at small sizes, such as model sizes sufficiently small to operate on-device. For example, an example command generation model according to example implementations of the present disclosure can have fewer than 10 billion parameters, such as fewer than 5 billion parameters, such as fewer than 1 billion parameters, such as fewer than 500 million parameters, such as fewer than 300 million parameters. In such examples, for instance, a command generation model can be small enough to execute on consumer-grade hardware (e.g., mobile devices, personal computers, tablets, wearables, etc.) or otherwise execute in dedicated instances for a user with low computational and energy costs.

A technical effect of example implementations of the present disclosure is increased energy efficiency in performing operations using machine-learned models, thereby improving the functioning of computers implementing such models. For instance, example implementations can provide for more energy-efficient training by initializing a training procedure using pre-trained model weights from a pre-trained image processing model. In some scenarios, increased energy efficiency can provide for less energy to be used to perform a given task (e.g., less energy expended to train the model, etc.). In some scenarios, increased energy efficiency can provide for more task(s) to be completed for a given energy budget (e.g., more training for a given amount of energy, such that per-iteration training cost is lower, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Various example implementations are described herein with respect to the accompanying Figures.

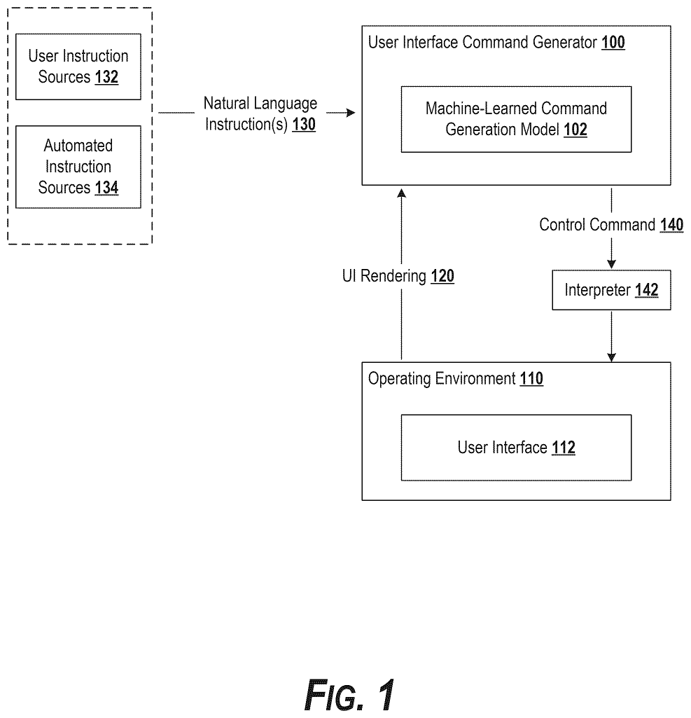

FIG. 1 is a block diagram of an example system implementing a user interface command generator 100 according to example aspects of the present disclosure. User interface command generator 100 can implement a machine-learned command generation model 102. User interface command generator 100 can facilitate interactions with an operating environment 110. Operating environment 110 can execute a user interface 112. User interface command generator 100 can receive a UI rendering 120 containing user interface image data that describes a state of user interface 112.

User interface command generator 100 can receive a natural language instruction 130 that describes an action to perform via user interface 112. Natural language instruction 130 can be obtained from one or more user instruction source(s) 132 or one or more automated instruction source(s) 134.

User interface command generator 100 can process UI rendering 120 and natural language instruction 130 using machine-learned command generation model 102 to generate control command 140. An interpreter 142 can receive control command 140 and execute an operation to control operating environment 110 to cause an interaction with user interface 112.

User interface command generator 100 can be implemented on a computing device or computing system to generate control commands based on graphical inputs. User interface command generator 100 can be implemented as a system service, as part of an operating system, as part of an application, as a web service, etc. User interface command generator 100 can interact with other system components using an application programming interface (API) configured to receive UI rendering 120 and natural language instruction 130. User interface command generator 100 can interact with other system components using an API configured to output control commands 140.

User interface command generator 100 can include machine-learned command generation model 102. User interface command generator 100 can include other components that operate in support of machine-learned command generation model 102. User interface command generator 100 can include, for example, input preprocessors that preprocess at least one of UI rendering 120 or natural language instruction 130 into a format suitable for processing by machine-learned command generation model 102. For instance, for machine-learned command generation models that operate over image patches extracted from UI rendering 120, an input preprocessor can scale input images up or down so as to extract the maximal number of fixed-size patches that still fit within an input size (e.g., a sequence length limit).

An input preprocessor can transform, augment, or otherwise modify UI rendering 120 to cause UI rendering 120 to conform to an input dimension or other input constraint of machine-learned command generation model 102. An input preprocessor can resize, rescale, crop, rotate, etc. An input preprocessor can recolor UI rendering 120. An input preprocessor can reformat UI rendering 120, encode or re-encode, or otherwise alter a storage or communication protocol used to store or communicate UI rendering 120.

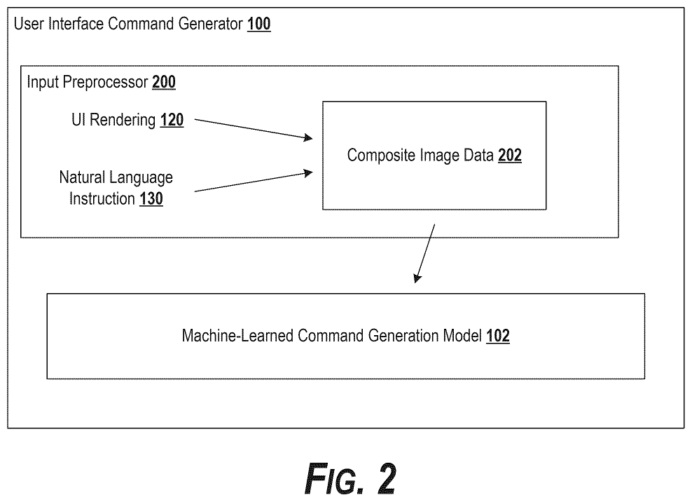

An input preprocessor can transform, augment, or otherwise modify natural language instruction 130 to conform to an input dimension or other input constraint of machine-learned command generation model 102. An input preprocessor can, for instance, render the text of natural language instruction 130 into instruction image data. The input preprocessor can combine the instruction image data with user interface image data. FIG. 2 illustrates an example input preprocessor combining UI rendering 120 and natural language instruction 130 into composite image data 202.

An input preprocessor can transform, augment, or otherwise modify natural language instruction 130 to improve a quality of natural language instruction 130. For instance, an input preprocessor can include a language processing model that rephrases natural language instruction 130 to improve a clarity or precision of natural language instruction 130. An input preprocessor can parse a task indicated in natural language instruction 130 into multiple subtasks to provide more precise instructions to machine-learned command generation model 102.

An input preprocessor can implement one or more language processing models to leverage additional context to disambiguate natural language instruction 130. For example, consider a natural language instruction “open the document.” Without context, this instruction might be ambiguous as it does not specify which document to open. However, if this instruction is given while a particular folder is open on user interface 112, and the status of being open is communicated to a language processing model, the language processing model can interpret natural language instruction 130 as referring to a document within that currently open folder. The language processing model can rephrase natural language instruction 130 to explicitly refer to the correct document. Other context sources can be used, such as system time, prior system activity or events, etc.

Operating environment 110 can be any of a variety of computing environments. The operating environment can be a hardware platform, a software platform, or a combination of both. Generally, operating environment 110 can host, execute, or otherwise provide resources for a variety of applications, tools, utilities, or other software components that interact with various hardware or software resources. These resources can support operation of user interface 112.

An example operating environment 110 is an operating system of a computing device, such as a server, a personal computer, a mobile device, a game console, a wearable device, etc. An operating system can manage hardware and software resources of a computing device and provide services for applications. An operating system can operate a system user interface (e.g., a graphical user interface, a command-line interface, a touch interface, a voice-controlled interface, etc.) that applications operating on the device can use to facilitate interaction with the computing device to perform tasks. The operating system can respond to system-level input commands that can be utilized by user interface command generator 100 to automate interactions with user interface 112.

Another example of operating environment 110 is an application running on a computing device or a server. The application can contain executable code causing a user interface to render on a computing device, providing a visual, auditory, or other sensory presentation of information, commands, data, and other content. Examples of such applications can include web applications, mobile applications, desktop applications, games, etc.

Operating environment 110 can be a virtual environment, such as a virtual machine or a container. These virtual environments can host and execute various software components, including operating systems, applications, and services. Each virtual environment can include its own user interface, which can be similar to or different from the user interfaces of the underlying physical device or host operating system.

User interface command generator 100 can operate within operating environment 110. For instance, user interface command generator 100 can integrate with the operating system, application, or other software components within the environment. For instance, user interface command generator 100 can be implemented as a system service, an application module, a plug-in, or any other integrated software component. In such cases, user interface command generator 100 can have direct access to various resources within the operating environment, such as user interface renderings, system-level input commands, and other system or application states. This can allow for highly efficient and responsive operation as generator 100 can directly monitor, interpret, and interact with the user interface 112 in real time.

For example, user interface command generator 100 can utilize APIs, libraries, or other system services provided by the operating environment to capture screenshots or renderings of the user interface, generate and issue system-level input commands, or access other relevant data or services. This direct integration can facilitate streamlined and efficient operation.

User interface command generator 100 can also operate outside of operating environment 110. For instance, user interface command generator 100 can operate on a separate computing device. For instance, operating environment 110 can execute on a target computing device. In integrated implementations, user interface command generator 100 can also execute on the target computing device. In other implementations, user interface command generator 100 can execute on another device, such as a controller computing device (e.g., separate and distinct from a target computing device).

User interface command generator 100 can interact with operating environment 110 through standardized interfaces, such as network interfaces, wireless or wired communication protocols, or other communication channels. Physical interfaces can also be used. For instance, user interface command generator 100 can execute on a computing system that receives natural language instruction 130 via a microphone, receives UI rendering 120 via a camera, and executes control command 140 via a robotic appendage by engaging with a physical interface of operating environment 110 (e.g., a touchscreen of a target computing device). User interface command generator 100 can capture screenshots or renderings of the user interface by requesting them from an API exposed by operating environment 110 or by otherwise receiving them from operating environment 110. User interface command generator 100 can issue system-level input commands 140 by sending them to an API exposed by operating environment 110.

Machine-learned command generation model 102 can be or include any of various types of machine learning models that are trained to generate control commands based on input data. These models can use supervised learning, unsupervised learning, semi-supervised learning, reinforcement learning, or any other type of machine learning to learn from examples, experiences, or other forms of training data.

Machine-learned command generation model 102 can be trained using a variety of training objectives, learning algorithms, and datasets. An example training objective includes an interface recognition objective based on the evaluation of a user interface structure generated based on processing a rendered training interface from a pre-training dataset. An interface recognition objective can allow the model to learn an understanding of the structure and semantics of user interfaces, and this understanding can be leveraged when processing UI rendering 120 for generating control command(s) 140.

In an example, a pre-training dataset can include a variety of rendered training interfaces. Each training interface can represent a different state of a user interface, such as a different screen of an application, a different stage of a task, a different layout or design, etc. These interfaces can be rendered into image data, which can be processed by the model being trained to generate a recognition output that recognizes one or more components of the user interface, such as a textual component (e.g., text fields, descriptions, headings, titles, captions, etc.), a structural component (e.g., a button, hyperlink, frame, checkbox, input element, etc.).

An example recognition output includes a structured representation of the user interface. The structured representation can capture various aspects of the user interface, such as the layout, the elements, the states of the elements, the relationships between the elements, the text content, the visual attributes, and other properties. This structured representation can serve as a compact and interpretable summary of the user interface. The structured representation can include HTML, XML, CSS, plain text, or other textual content in a structured format (e.g., having sections or divisions corresponding to sections or divisions of the interface).

To train the model, the interface recognition objective can compare a recognition output generated by the model with a ground truth recognition output provided in the pre-training dataset. The ground truth can be obtained in a self-supervised fashion: for instance, a structured representation can be rendered (e.g., by an application or browser) to obtain the rendered training interface, forming a training pair. The comparison between the generated structured representation and the ground truth can produce a measure of the difference or error between the model's output and the ground truth, which can be used as a learning signal to update the parameters of the model. The model can be trained using various learning algorithms to minimize this error, such as gradient descent, backpropagation, or other optimization methods. Other recognition outputs can include textual recognition outputs that can be compared with ground truth text data associated with the user interface. Other recognition outputs can include recognition of button elements, recognition of input fields, recognition of webpage hierarchies, etc.

Using this interface recognition objective, the model can learn to understand the content and structure of user interfaces based on images thereof. This can enable the model to understand the structure and semantics of user interfaces, which can help later checkpoints of the model to generate effective control commands for interacting with these interfaces.

Machine-learned command generation model 102 can be trained using an interface navigation objective based on the evaluation of a user interface command generated by processing a rendered training interface from a fine-tuning dataset. This approach can allow the model to learn an understanding of how to navigate user interfaces and perform tasks, enabling it to generate effective control commands for interacting with these interfaces.

The fine-tuning dataset can include a variety of rendered training interfaces, each associated with a specific navigation task. Each training interface can represent a different state of a user interface, such as a different screen of an application, a different stage of a task, a different layout or design, etc. These interfaces can be rendered into image data which can be processed by the model, along with a natural language instruction describing the navigation task, to generate a user interface command.

The fine-tuning dataset can include labels or demonstrations of actions taken to navigate the rendered interfaces. These signals can be used for supervised learning or behavioral cloning.

The fine-tuning dataset can be the same as or different from the pre-training dataset.

The generated user interface command can specify one or more system-level input commands that can be executed to perform the navigation task. This can include, for example, clicking on certain elements, typing text into fields, dragging items, scrolling, or other types of user interface interactions.

To train the model, the interface navigation objective can compare the user interface command generated by the model with a ground truth user interface command provided in the fine-tuning dataset. This comparison can produce a measure of the difference or error between the model's output and the ground truth, which can be used as a learning signal to update the parameters of the model. The model can be trained using various learning algorithms to minimize this error, such as gradient descent, backpropagation, or other optimization methods. This fine-tuning process can effectively tailor the pre-trained model to the specific task of generating user interface commands, leveraging the structural understanding of GUIs learned during the pre-training phase.

The fine-tuning dataset can include reward signals. Reward signals can be used for reinforcement learning. Reinforcement learning algorithms can be used to fine-tune the model to perform higher-value actions, or actions that are more likely to lead to higher-value states (with value based on a reward amount).

Machine-learned command generation model 102 can be trained using a text recognition objective based on the evaluation of textual content recovered from an image of a text snippet. This approach helps the model to develop the ability to recognize and interpret text from image data. This objective can form the first stage of pre-training. The training dataset can consist of numerous images of text snippets, each associated with the correct textual content. These text snippets could be extracted from various sources. The corresponding correct textual content provides the ground truth for the text recognition task. When training, the model can process an image of a text snippet as input to recover the textual content. The model's output can be a string of characters representing the recovered textual content. The text recognition objective can compare the model's output with the ground truth textual content, producing a measure of the difference or error. This error can be used as a learning signal to update the parameters of the model. The model can be trained using various learning algorithms, such as backpropagation, to minimize this error.

Machine-learned command generation model 102 can include an image encoder and a text decoder. The image encoder can process image data and convert it into a latent representation. For instance, the image encoder can receive a screenshot or a rendering of a GUI as input. Using layers of convolutional neural networks, patch extractors, transformer models, or other image processing techniques, the image encoder can identify and extract key features from the GUI, such as the layout of the interface, the elements present, their states, their positions and other graphical properties. The output of the image encoder can be a latent vector or a set of vectors that represent these features in a compressed form.

The text decoder can convert the latent vectors into textual commands. The text decoder can use techniques from natural language processing, such as recurrent neural networks, transformers, or other sequence generation techniques, to generate a sequence of words or other textual tokens that express a command. The generated command reflects the information encoded in the high-dimensional vectors and can be interpreted by the interpreter to control the user interface.

Unified model architectures can be used (e.g., without discrete encoders portions and decoder portions). For instance, machine-learned command generation model 102 can include a decoder-only transformer model that processes image input and outputs text data. A decoder-only transformer model can first convert an image input into a sequence of tokens, each representing a small patch of the image. These tokens can then be processed by the transformer model. The model can learn to recognize patterns in the token sequence that correspond to different UI elements, their states, and their relationships. It can also learn to recognize and interpret textual content within the GUI by using techniques similar to optical character recognition. Once the image data has been processed, the decoder-only transformer model can generate a sequence of output tokens, each representing a word or symbol in a generated control command. The model can generate this sequence one token at a time, using a self-attention mechanism to consider the context of the previously generated tokens when deciding on the next token. In this example, a decoder-only transformer model can effectively combine the capabilities of an image encoder and a text decoder into a single, unified model. Encoder-only models can also be used.

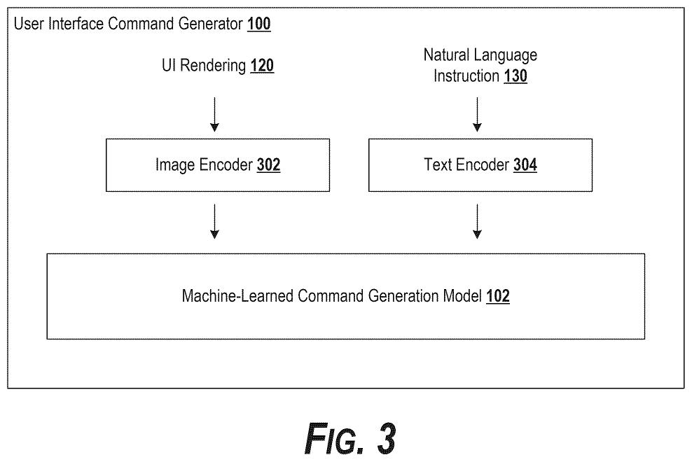

Multiple encoders can be used. FIG. 3 illustrates one implementation of multiple encoders, such as an image encoder for encoding UI rendering 120 and a text encoder 304 for encoding natural language instruction 130.

For instance, machine-learned command generation model 102 can include a natural language encoder, an image encoder, and a text decoder to process natural language instructions and user interface image data in order to generate commands. The natural language encoder can process a textual input, such as the natural language instruction, and encode it into a first latent representation. This encoding process can involve projecting each word or token in the instruction into a high-dimensional vector. The output of the natural language encoder can be a first latent representation that captures the meaning of the natural language instruction.

The image encoder can process the user interface image data and encode it into a second latent representation. This can involve extracting features from the image such as edges, shapes, colors, and other visual properties using vision transformers, convolutional neural networks or other image processing techniques. The output of the image encoder can be a second latent representation that captures the visual characteristics of the user interface.

The text decoder can ingest both the first and second latent representations as input. The text decoder can generate commands based on this combined input.

Machine-learned command generation model 102 can include a language model for predicting sequences of tokens. Tokens can represent the entirety or a part of a control command to be executed. To generate a control command, the model can start with an initial state and predict the first token of the command. This prediction can be based on the state of the user interface and the natural language instruction. The first token could represent, for instance, the type of action to perform (e.g., “click,” “type,” “scroll,” etc.). After predicting the first token, the model can update its state based on the predicted token and then predict the next token in the sequence. This process can be repeated until the model predicts a special end-of-sequence token, indicating that the command is complete.

The prediction of each token can be probabilistic, with the model assigning a probability to each possible token based on its current state. This can allow the model to represent uncertainty and to consider multiple possible commands at each step. To decide which sequence of tokens to choose as the final command, the model can use a technique such as beam search. Beam search is a search algorithm that explores multiple possible sequences at each step and keeps only the most promising ones, known as the “beam.” The size of the beam (e.g., the number of sequences to keep at each step) can be a configurable parameter of the algorithm.

User interface command generator 100 can implement various different policies with respect to selecting commands. In an example, a greedy policy can be used, selecting the highest scoring or most probable action at each step. A modified greedy policy can be used to help prevent the agent from getting stuck in cycles. User interface command generator 100 can track which actions have been taken for a given observation and select the highest probability action in the beam that has not previously been taken given the current observation.

User interface 112 can include a software component that is configured to facilitate interaction between a user (or a software agent) and a software application, an operating system, a web service, a device driver, or any other software component. User interface 112 can include visual, auditory, haptic, or other sensory interfaces that present information, commands, data, and other content that can be manipulated or interacted with by a user or a software agent.

User interface 112 can include graphical user interfaces (GUIs), which can include visual representations of objects which can be manipulated or interacted with by a user. GUIs can include buttons, icons, menus, dialogue boxes, sliders, forms, text boxes, images, videos, and other graphical elements.

The graphical elements in the GUI can represent various functions and operations of an application, a tool, a utility, or other software components running within the operating environment 110. Each graphical element can respond to user inputs in a specific way, and the response can be defined by the underlying software component represented by the graphical element. For instance, a button on the GUI can initiate a specific operation when clicked, a text box can accept text input from a user, a slider can be moved to adjust a value, and so on.

User interface 112 can be dynamic, meaning that its graphical elements can change in response to user inputs, system states, or other events. For example, new windows or dialog boxes can appear, menus can be expanded or collapsed, icons can be moved or resized, text can be added or modified, and the like.

User interface 112 can be rendered on a display device, such as a computer monitor, a TV screen, a projector, a mobile device screen, a wearable device screen, etc. The rendering of the GUI can be captured as UI rendering 120, which can be a screenshot, a video stream, a 3D model, a virtual reality scene, an augmented reality overlay, or any other graphical representation of the GUI suitable for processing by user interface command generator 100.

User interface 112 can include web-based interfaces. Web-based interfaces can be rendered by web browsers and allow users or software agents to interact with web applications or websites. Web-based interfaces can include elements defined by HTML, CSS, JavaScript, or other web technologies.

User interface 112 can also include command-line interfaces (CLIs). CLIs can allow users or software agents to interact with software components by entering textual commands. CLIs can be used to automate tasks, configure software components, or interact with software components that do not have a graphical user interface.

UI rendering 120 can include a graphical representation of a state of user interface 112 at a particular point in time. UI rendering 120 can be generated from any source that can visually represent the state of the user interface. Such sources can include, but are not limited to, screenshots, video streams, 3D models, virtual reality scenes, augmented reality overlays, and other types of graphical representations.

An example type of UI rendering 120 is a screenshot. A screenshot can be an image that captures the visible items displayed on a display interface at a specific moment. Screenshots can be taken manually by a user or automatically by a system service or application. In the context of the user interface command generator 100, screenshots can be taken periodically or in response to specific events to monitor the state of the user interface. Once taken, the screenshot can be processed by the user interface command generator to identify the graphical elements present in the user interface and their states, and to generate appropriate system-level input commands for interacting with these elements.

An example type of UI rendering 120 involves headless rendering to an image file. Headless rendering can refer to the process of generating a graphical output (such as an image file) from a user interface without displaying the interface on a screen. This can be useful so that the state of the user interface can be captured and processed, but not necessarily displayed to a user. It can also be useful in scenarios where the display device is not readily available or where the display of the user interface would interfere with other tasks. For instance, headless rendering can execute in the background while a user performs other tasks in a foreground. In such cases, the user interface can be rendered directly to an image file, which can then be ingested and processed by user interface command generator 100 without disrupting other tasks.

Natural language instruction 130 can include any form of instruction given to the user interface command generator 100 using natural language. An example of natural language can be a language developed naturally among humans, as opposed to a structured or formal language like computer code. Natural language instruction 130 can express a task, an operation, an action, a query, or any other form of command or request that can be executed or otherwise processed using user interface 112. While examples described herein refer to instructions in natural language, it is to be understood that example systems can process instructions in other languages (e.g., computer code, etc.) in addition to or in alternative to natural language.

Natural language instruction 130 can be provided in various formats, including spoken language, text, or any other form of natural language communication. When provided as spoken language, natural language instruction 130 may be converted to text using speech recognition systems before being processed by user interface command generator 100. When provided as text, text can be entered using a keyboard, a touchscreen, a stylus, or any other input device, or it could be generated by a software application, a digital assistant, a script, or any other source of text data.

User instruction sources 132 can include various input devices or sources that can provide natural language instruction 130 to user interface command generator 100. These sources can capture or generate user instructions in various forms, such as spoken language, text, gestures, or other forms of communication.

Microphones can be an example source for spoken language instructions. A microphone can capture a user's voice and convert it into an electronic signal that can be further processed by speech recognition systems to generate a textual representation of the spoken language instruction. Keyboards can be an example source for text-based instructions. A user can manually type instructions into a text input field using a keyboard. These instructions can then be directly processed by user interface command generator 100. In addition to physical keyboards, virtual keyboards on touchscreens or other input devices can also be used. Cameras can capture visual inputs, such as hand gestures, facial expressions, or written notes, which can then be interpreted as natural language instructions. For example, sign language interpreted by a camera or a handwritten note captured and interpreted via optical character recognition (OCR) technology can provide a natural language instruction.

Messages from various communication channels, such as emails, text messages, instant messages, social media posts, or other types of digital messages, can also be used as sources of natural language instructions. These messages can be processed and interpreted by user interface command generator 100 to extract the natural language instructions. Notes, including digital notes in note-taking applications, sticky notes, or other types of notes, can also provide natural language instructions. For instance, a to-do list in a note-taking application could include a series of instructions for tasks to be performed.

Automated instruction sources 134 can include various software components or systems that can automatically generate natural language instruction 130 for user interface command generator 100. These sources can provide instructions programmatically, based on predefined rules, machine learning algorithms, user inputs, or other factors.

Digital assistants can be an example source of automated instructions. Such assistants can understand natural language commands from users, perform tasks, and provide responses. When integrated with user interface command generator 100, these digital assistants can generate natural language instructions based on user commands or other contextual factors. For example, a user might ask a digital assistant to “schedule a meeting for next week,” and the assistant can generate a series of natural language instructions for interacting with a calendar application's GUI to perform this task.

Chatbots can also provide automated instructions. Chatbots can include software applications designed to simulate conversation dialogue, such as within messaging platforms. Chatbots can provide natural language instructions based on the conversation flow, user inputs, or predefined scripts. For example, in a customer service scenario, a chatbot might generate instructions to navigate through a company's (or third party's) website or application based on the customer's inquiry.

Automated scripts can also serve as a source of automated instructions. These scripts, which can be written in various programming languages, can generate natural language instructions based on predefined rules or algorithms. For example, a script might generate instructions to automatically perform certain tasks at specific times or in response to specific events.

Control command(s) 140 can include any command or instruction that can be executed by operating environment 110 to control, manipulate, or interact with user interface 112. These commands can be based on the output of the machine-learned command generation model 102 and can be generated in response to a natural language instruction 130.

Control commands 140 can take various forms, including system-level input commands, application-specific commands, or other forms of control signals or data. These commands can represent user actions such as clicks, taps, keypresses, gestures, or other types of user inputs that can be processed by the user interface.

System-level input commands can include commands that simulate user inputs at the operating system level. For example, these commands could simulate mouse events like clicks or movements, keyboard events like keypresses or combinations, or touchscreen events like taps, swipes, or multi-touch gestures. These commands can be interpreted by the operating system and passed to the appropriate application or component of the user interface.

Application-specific commands can include commands that are specific to a certain application or software component. These could include commands to call certain functions or methods, change certain properties or states, or interact with certain elements of the user interface in a way that is specific to the application. These commands can be executed by the application in response to the control command.

Example system-level commands can include, for instance, a click or selection command, a keypress command, a scroll command, a cursor movement or drag command, etc. Each command can be parameterized with, e.g., coordinates or other information that describes how to implement the command.

Control command(s) 140 can be directly executable. For instance, machine-learned command generation model 102 can directly decode a text string that includes an executable command (e.g., for input to a command-line interface, a script, or other executable environment) that can be directly executed to implement a click at a given set of coordinates.

Control command(s) 140 can be platform independent. For instance, a “command” might not be directly executable in a given operating environment. For instance, machine-learned command generation model 102 can output a text string “click 10 34” to indicate a click command at coordinates 10 and 34 (e.g., relative coordinates to an input frame). Operating environment may be unable to directly execute such a string.

Interpreter 142 can include various software components or systems that are configured to receive control commands 140 from user interface command generator 100 and convert these commands into appropriate actions that can be executed in or by operating environment 110. Interpreter 142 can interface with low-level system APIs, device drivers, or other system components to implement the desired actions, such as interacting with the user interface, running functions, or modifying state variables.

An example of interpreter 142 is a system component that uses the Windows function SendInput. SendInput is a function provided by the Windows operating system that synthesizes keystrokes, mouse motions, and button clicks. When interpreter 142 receives a control command such as “click X Y” it can call the SendInput function with parameters that emulate a mouse click at the specified screen coordinates. In this manner, for instance, the action of clicking at a specific location on the screen can be automated while allowing user interface command generator 100 to remain platform agnostic.

Another example of interpreter 142 is a component that uses Selenium WebDriver for automating web applications. Selenium WebDriver is a tool for automating browsers, and it provides a simple API to write functional/acceptance tests using browser interactions. When interpreter 142 receives a control command such as “click X Y,” it can translate this instruction into a WebDriver click( ) command that simulates a mouse click.

Interpreter 142 can operate at various levels of granularity. For example, at a high level, interpreter 142 can execute complex commands that perform multiple actions, such as filling out a form or navigating a multi-step workflow. At a low level, interpreter 142 can execute simple commands that perform basic actions, such as clicking a button or entering text into a field.

Interpreter 142 can include deterministic logic that processes the control commands 140 and identifies the control functions that correspond to these commands. This deterministic logic can be based on predefined rules, mappings, or algorithms that associate each possible command with a specific control function. For each control command 140 received, the deterministic logic of interpreter 142 can parse or otherwise process the command to identify its components, such as the command type, target, parameters, or other data. The deterministic logic can then look up or compute the corresponding control function based on this identification. This can involve, for example, consulting a command-function mapping, running an algorithm, selecting a function from a library, generating a function dynamically, or any other method of determining a control function from a command.

Once the corresponding control function is identified, interpreter 142 can execute or call this function to perform the desired action in operating environment 110. The function can interact with the underlying system, application, user interface, or other components to carry out the action specified by the control command. This can involve, for example, issuing system-level input events, calling application-specific functions, manipulating data or state variables, or any other control operations.

Interpreter 142 can include a machine-learned classifier that processes the control commands 140 and predicts the control functions that correspond to these commands. This machine-learned classifier can be trained on a set of examples that map control commands to corresponding control functions, allowing it to generalize from these examples to predict the appropriate control function for new commands.

The machine-learned classifier can take the form of a variety of machine learning models, such as decision trees, support vector machines, neural networks, or any other type of model that can learn from examples to make predictions. The specific choice of model can depend on various factors, such as the complexity of the command-function mapping, the availability of training data, computational resources, and others.

Upon receiving a control command 140, the machine-learned classifier within interpreter 142 can process the command to extract features, which can include various elements of the command such as command type, target, parameters, or other components. These features can then be input to the machine-learned classifier, which can output a prediction of the most likely control function to correspond to the command.

Once the predicted control function is identified, interpreter 142 can execute or call this function to perform the desired action in operating environment 110. The function can interact with the underlying system, application, user interface, or other components to carry out the action specified by the control command.

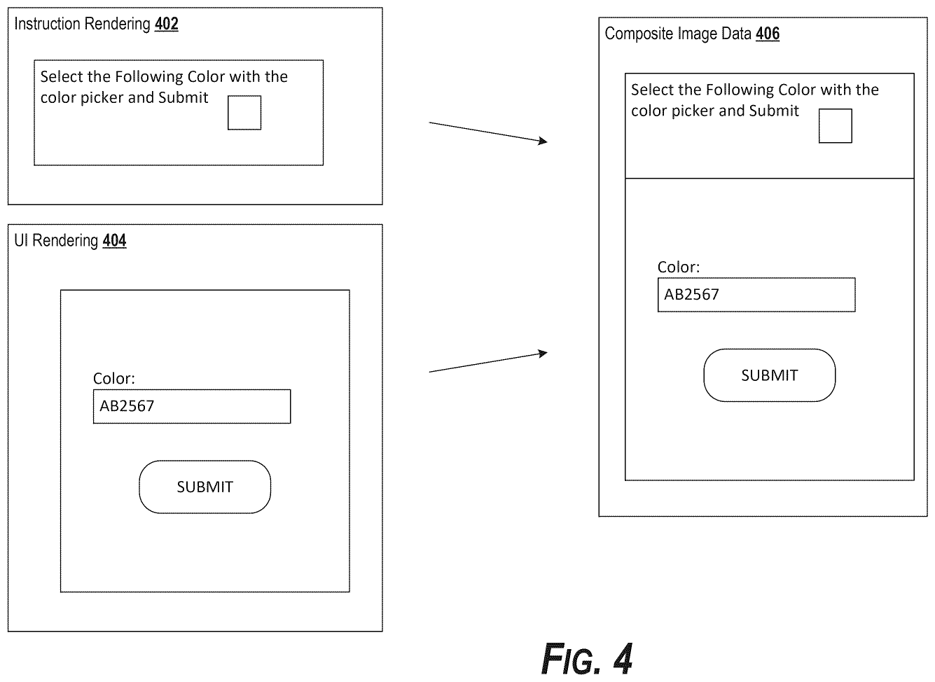

FIGS. 4 to 9 illustrate an example processing flow by which user interface generation system 100 can interact with a user interface. FIG. 4 illustrates how an instruction rendering 402 (e.g., image data depicting a natural language instruction) can be combined with a UI rendering 404 to obtain composite image data 406.

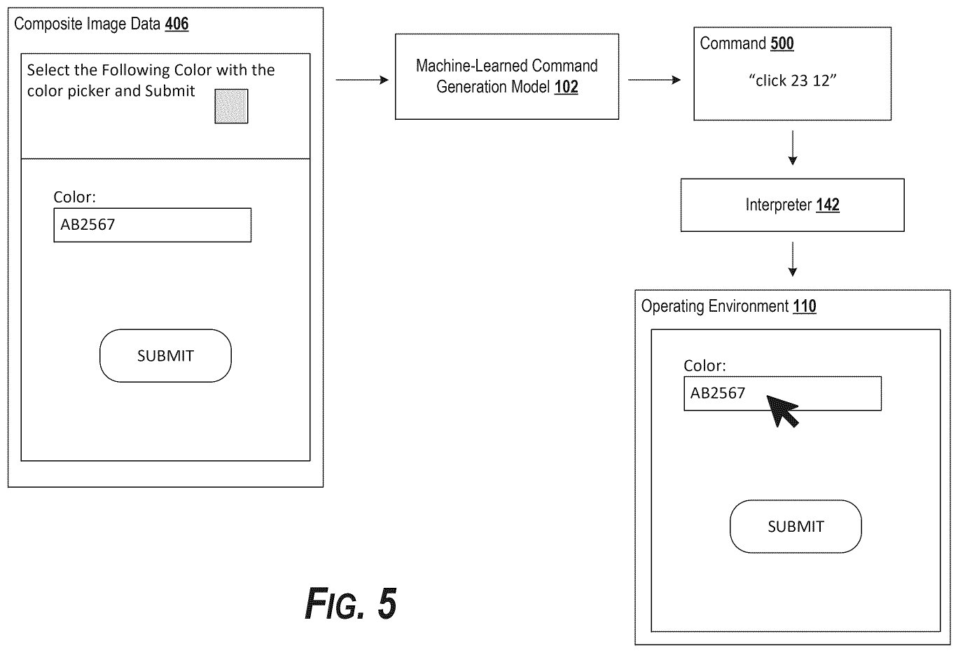

FIG. 5 illustrates an initial forward pass through the system. Machine-learned command generation model 102 can process composite image data 406 to generate command 500, a string “click 23 12.” Command 500 can pass through interpreter 142 to cause operating environment 110 to initiate a click action on a location corresponding to the coordinates 23 12: for instance, the color selection box.

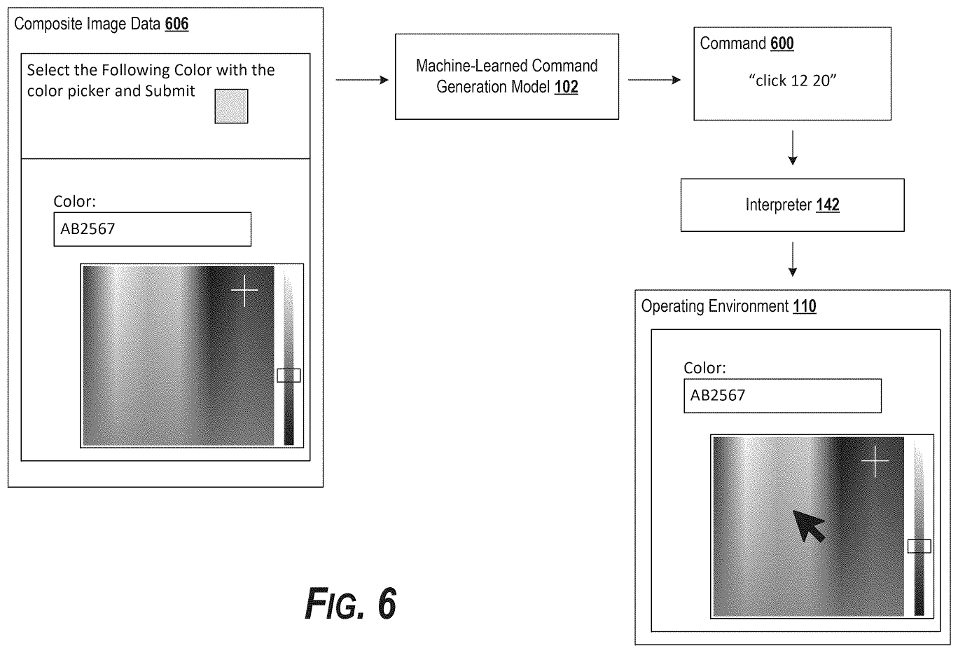

FIG. 6 illustrates a second forward pass based on updated composite image data 606 (e.g., using a new UI rendering). Machine-learned command generation model 102 can generate command 600, a string “click 12 20.” Command 600 can pass through interpreter 142 to cause operating environment 110 to initiate a click action on a location corresponding to the coordinates 12 20: for instance, a screen location corresponding to a hue matching the requested color.

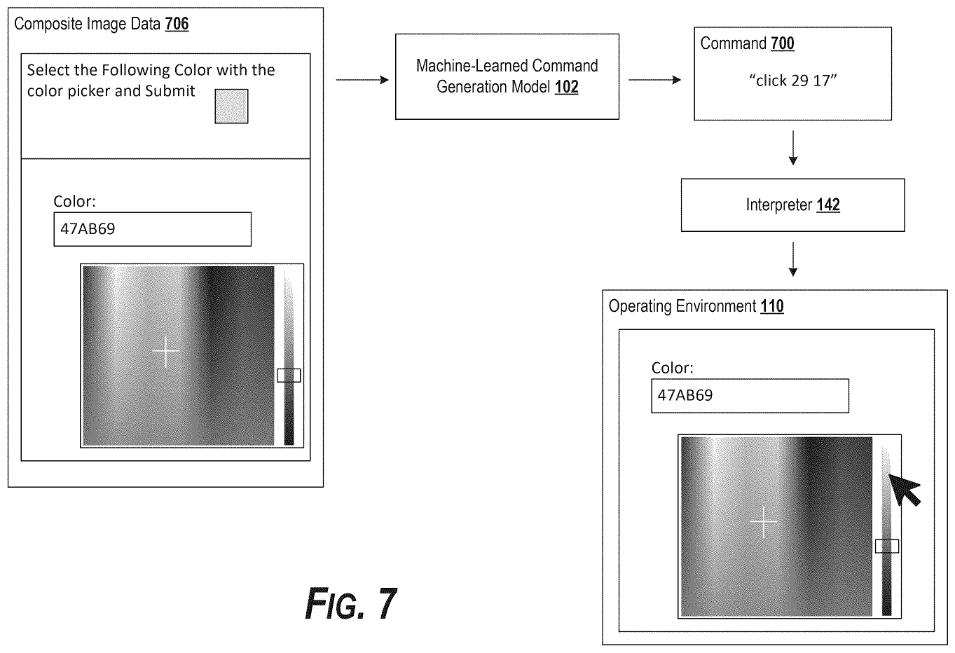

FIG. 7 illustrates a third forward pass based on updated composite image data 706 (e.g., using a new UI rendering). Machine-learned command generation model 102 can generate command 700, a string “click 29 17.” Command 700 can pass through interpreter 142 to cause operating environment 110 to initiate a click action on a location corresponding to the coordinates 29 17: for instance, a screen location corresponding to a value matching the requested color.

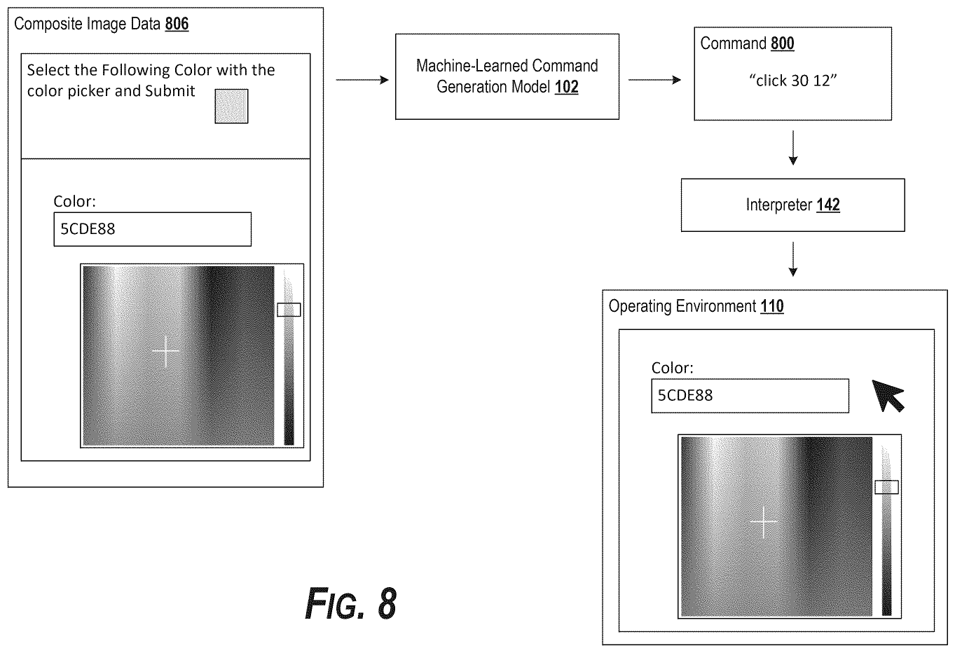

FIG. 8 illustrates a fourth forward pass based on updated composite image data 806 (e.g., using a new UI rendering). Machine-learned command generation model 102 can generate command 800, a string “click 30 12.” Command 800 can pass through interpreter 142 to cause operating environment 110 to initiate a click action on a location corresponding to the coordinates 30 12: for instance, a screen location corresponding to an area outside the color selection pane (e.g., to close the color selection pane).

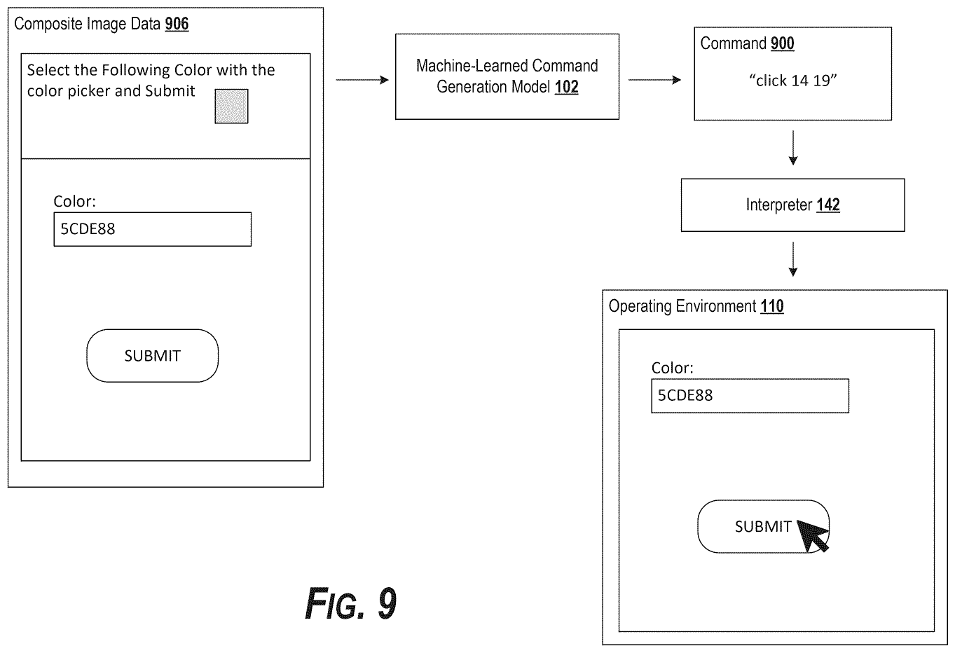

FIG. 9 illustrates a fifth forward pass based on updated composite image data 906 (e.g., using a new UI rendering). Machine-learned command generation model 102 can generate command 900, a string “click 14 19.” Command 900 can pass through interpreter 142 to cause operating environment 110 to initiate a click action on a location corresponding to the coordinates 14 19: for instance, a screen location corresponding to the Submit button.

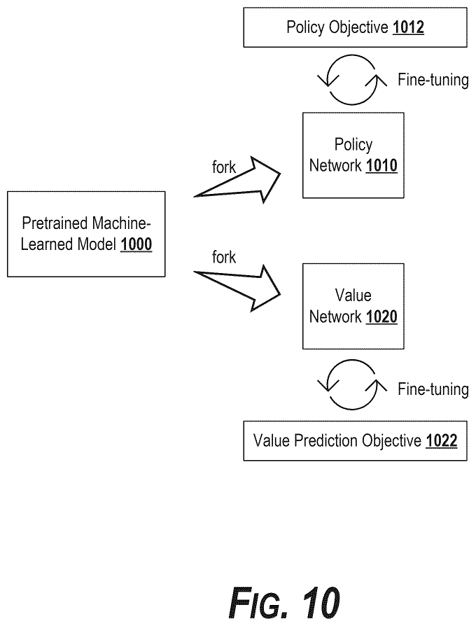

FIG. 10 is a block diagram of an example system for generating models for performing tree-search based reinforcement learning. A pre-trained machine-learned model 1000 can be forked into two separate model development pipelines for training a policy network 1010 (e.g., using a policy objective 1012) and a value network 1020 (e.g., using a value prediction objective 1022).

Pre-trained machine-learned model 1000 can be, for instance, a machine-learned image processing model used as an initialization of machine-learned command generation model 102. Pre-trained machine-learned model 1000 can be pre-trained using an interface recognition objective based on an evaluation of a user interface structure generated based on processing a rendered training interface from a pre-training dataset. Pre-trained machine-learned model 1000 can be, for instance, a pre-trained sequence processing model, such as a transformer-based model. An example pre-trained machine-learned model 1000 is Pix2Struct, from Lee et al., Pix2Struct: Screenshot Parsing as Pretraining for Visual Language Understanding, Arxiv (Jun. 15, 2023), https://arxiv.org/pdf/2210.03347.pdf.

A model fork can include a replicated instance of model parameters, or a designation to permit updates to model parameters without globally overwriting all other instances of the model parameters. For example, a fork of model 1000 can allow a snapshot or checkpoint of the model to be further developed or further trained for different tasks. Model 1000 can generate multiple forks that permit training for multiple different tasks separately or independently. In this manner, for instance, model 1000 can be trained using policy objective 1012 to obtain policy network 1010, and model 1000 can be trained using value prediction objective 1022 to obtain value network 1020, without crosstalk between the training tasks.

Policy network 1010 can be a model fork trained to encode a policy for generating commands based on input image data. Policy network 1010 can be machine-learned command generation model 102.

Policy objective(s) 1012 can be the objectives used to train machine-learned command generation model 102, such as an interface navigation objective based on an evaluation of a user interface command generated based on processing a rendered training interface from a fine-tuning dataset.

Value network 1010 can be a model fork trained to predict a value or expected reward based on a current state of a user interface or a selected action for navigating a user interface. For instance, value network 1010 can be trained to decode (e.g., textually) or numerically regress a quantity of expected reward.

Value prediction objective 1022 can include an evaluation of the predicted value or reward and an actual or measured value or reward flowing from a given state or selection of an action. For instance, a dataset can be labeled with reward values at different states of a user interface. These reward values can supervise the predictions of value network 1010 during fine-tuning. The predictions of value network 1010 can be trained on a per-state basis, or value network 1010 can be trained to directly generate a cumulative value for traversing multiple states toward a goal state of the user interface.

Once trained, value network 1010 can be used to help train policy network 1010. Value network 1010 can be used to reinforce behavior of policy network 1010 that leads to higher-value user interface commands. Value network 1010 can be used to guide a tree search for training policy network 1010.

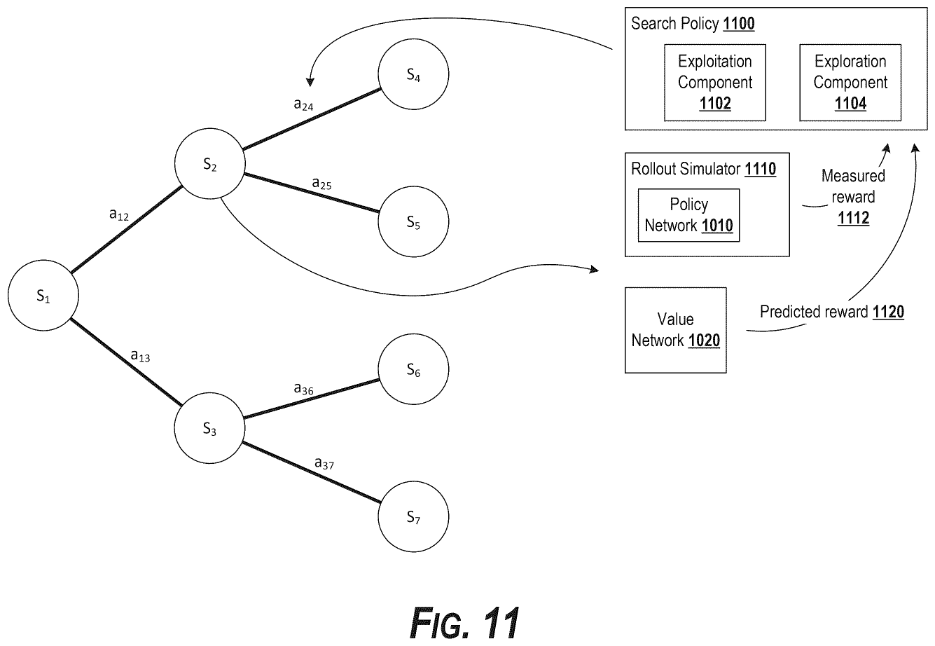

FIG. 11 is an example illustration of aspects of a tree search according to example implementations of the present disclosure. A “tree” can include a graph having nodes S₁ to S₇ and edges disposed therebetween, with edge labels indicating the node numbers connected by the edge. A trajectory through the tree can include a path from the root S₁ to a leaf node (e.g., S₄) determined by taking one or more actions (e.g., a₁₂ and a₂₄). These trajectories can be used for training policy network 1010 as described herein.

To obtain a trajectory, in an episode or iteration of walking through the tree, a search policy 1100 can select an action to perform to traverse from one node of the tree to a next node. Search policy 1100 can include an exploitation component 1102 that encourages selection of actions that are known or expected to generate high reward. Search policy 1100 can include an exploration component 1104 that encourages selection of actions that are diverse or different from previously selected actions for a given state.

An example reward function can include a positive component based on an environment reward and a negative component penalizing path length.

Search policy 1100 can be based on inputs from a rollout simulator 1110 that simulates a series of actions flowing from a current node and reports a measured reward 1112 to search policy 1100. Search policy 1100 can be based on inputs from value network 1020 that predicts a predicted reward 1120 looking forward from the current node.

As illustrated, a current node is S₂. Rollout simulator 1110 can apply a rollout policy (e.g., a greedy search policy) using policy network 1010 to select highest-ranked (or top-K ranked) actions. Each action selection can generate multiple possible trajectories flowing from S₂ (e.g., leading to S₄ or S₅). Rollout simulator 1110 can measure the known value of each state (e.g., obtained using a reward function defined for the environment) traversed in the possible trajectories.

Value network 1010 can also process state S₂ (e.g., an image of the UI at the state). Value network 1010 can generate predicted reward 1120.

Search policy 1100 can select a next action for the trajectory based on measured reward 1112, predicted reward 1120, or a weighted combination of measured reward 1112 and predicted reward 1120. For instance, an exploitation component 1102 can be determined based on measured reward 1112, predicted reward 1120, or a weighted combination of measured reward 1112 and predicted reward 1120.

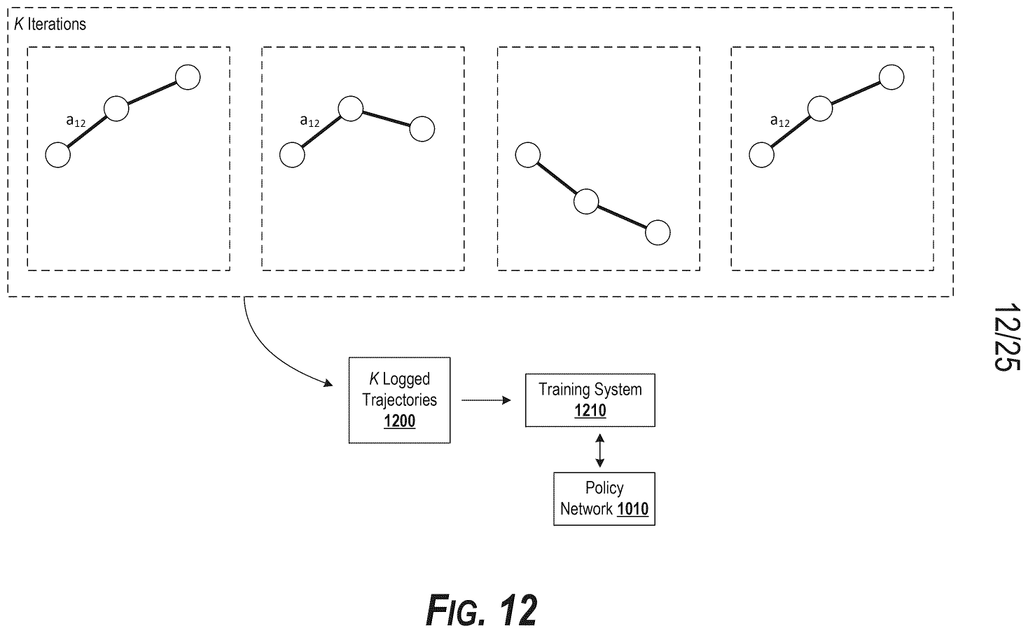

FIG. 12 illustrates how, over K iterations or episodes, multiple different trajectories can be obtained, such as K logged trajectories 1200. The K logged trajectories 1200 can be input to a training system 1210 that trains policy network 1010 to learn from trends observed over the K logged trajectories 1200. For instance, the search policy can select certain actions multiple times in K logged trajectories 1200. Repeated selection of an action across K logged trajectories 1200 can indicate that the action is associated with a high measured reward, predicted reward, or otherwise leads to favorable outcomes.

For example, in K logged trajectories 1200, action a₁₂ is repeated more often than other actions. Training system 1210 can update one or more parameters of policy network 1010 to increase a likelihood that policy network 1010 would select a₁₂ given state S₁. For instance, supervised training techniques can be used with a “label” effectively determined using a frequency with which an action appears.

Example formulations are described within the following example problem setting. Consider an environment with states S and actions A. The reward function, r(s), returns a scalar corresponding to the reward given for transitioning to state s∈S, and is described below. MiniWob++ environments can be randomly generated, but transitions can be deterministic within an environment generated by a particular random seed. The transition function, f(s, a), returns the state resulting from taking action a∈A in state s∈S. Consider a surrogate reward r(s)=αₛ+rₜ(s), where αs provides a small negative reward that encourages shorter trajectories without unnecessary actions. The term rₜ(s) is the raw reward from the MiniWob++ environment if s is a terminal state and the raw reward is >0.8, or 0 otherwise. An example value for αₛ=−1/30. In an example selection of tasks, the tasks can be completed within 30 steps, so this value is small enough to ensure a positive reward is possible for all tasks. Additionally, the penalty is small enough such that in practice the agent should not be incentivized to sacrifice raw reward to reduce the number of steps taken.

For an example value network, the value function v^{π}(s) for a given policy π can be the expected future rewards from state S if actions are selected according to policy π. The optimal value function, v*(s), can be the expected future rewards if optimal actions are chosen. An approximation of this function can be learned as v_{ϕ}(s)≈v*(s), parameterized as a PIX2STRUCT-initialized model with parameters ϕ, which are referred to as the value network. The model is trained on transitions from the human demonstrations, which can demonstrate close to optimal behavior in many cases. For every state in the human demonstrations, the actual future rewards can be computed for the given episode, according to the surrogate reward. These future rewards can be mapped to discrete bins and represented as integers in the PIX2STRUCT decoder (e.g., tokens corresponding to integer values). At inference time, the mean of the distribution over these discrete bins can be approximated by considering the top-n predictions from the model using beam search (with n=3), weighted proportional to their respective probabilities.

For an example policy network, a fork of the PIX2STRUCT model tuned to generate actions (e.g., termed PIX2ACT) can be the policy network, with parameters θ. A greedy policy (or modified greedy policy, as described herein) π_{θ}(s) selects the action a with the highest approximate probability p_{θ}(a|s) in the top-k beam.

For an example search policy, a lookahead search can be used to implement a policy, π*_{θ}(s), which leverages interactions with the environment (f(s, a) and r(s)) to select actions in a more optimal way than the greedy policy π_{θ}(s). Both the policy network and value network can be used to constrain and prioritize the search. Example implementations of MCTS can perform K rounds of traversing a search tree with nodes corresponding to states, and edges corresponding to actions. K=16 was used for tests described herein.

The search tree can be initialized with a single root node for state s. Each round can start at s and traverse the tree. At each step t of a given round, an action aₜ can be selected for state sₜ, where aₜ=maxₐ Q(sₜ, a)+U(st, a). Q(st, a) can be an exploitation term, such as an average reward over all rounds that have traversed the associated edge. Q can be based on actual accumulated rewards during tree traversal and the value estimates of leaf states generated with the value network. U(st, a) can be a term that encourages exploration. An example expression of U is

$$U ( {s}_{t} , a ) = c \cdot {p}_{θ} ( a \vert s ) \cdot \frac{\sqrt{N ( {s}_{t} )}}{1 + n ( {s}_{t} , a )}$$

where n(sₜ, a) is the number of times action a has been selected from state sₜ, N(sₜ) is the total number of times state sₜ has been visited, and c is a scalar hyperparameter. An example value is 0.1.

The policy network can bias the exploration term. To constrain the search, the search policy can consider the top-k actions according to the policy network, where k=8 in an example. In an example, the search policy selects an action aₜ for state sₜ which has never been previously selected from sₜ, then the episode ends and a new leaf state, s_{L}=f(sₜ, a), can be added to the search tree. If s_{L} is not a terminal state, then the system can estimate its value (i.e. future returns) using both the value network and a rollout with the greedy policy. Specifically, in an example, the system can estimate its value as λ*v^{ϕ}(s_{L})+(1−λ)*v^{π}_{θ}(s_{L}) where v^{π}_{θ}(s_{L}) is equal to the actual returns from following the policy π_{θ} starting at s_{L} for a maximum of 20 steps, with actual returns clipped to a minimum value of 0. The term λ can be understood as a mixing parameter. An example value is 0.1.

For challenging environments, rollouts can sometimes fail to find a terminal state with positive reward, and in such cases rollouts may not be very informative. On the other hand, the value network can provide suboptimal value estimates for certain states, especially if they are not well represented in the human demonstrations. By combining both methods in a weighted combination, example implementations can provide a better approximation of the value of leaf states. Returns can be propagated up the tree to each parent s′ to update Q(s′, a). As Q(s_{L}, a) is undefined prior to selecting a from s_{L} for the first time, Q(s_{L}, a) can be initialized for each action to be equal to the initial value estimate of s_{L} plus αₛ. To understand the impact of rollouts and value estimates using the value network, Table 1 compares mean scores over 12 challenging MiniWob++ tasks for different values of λ: 0 (rollout only), 0.1 (both rollout and value network), and 1 (value network only). The table also includes the mean score using the greedy policy for reference. These results use the policy network and value network trained on the human demonstrations. The results show that using a combination of rollouts and the value network gives the best results. The value network is especially useful for challenging tasks that require longer trajectories, such as number-checkboxes, relative to using rollouts only.

TABLE 1
Mean scores for different search policies
over 12 MiniWob++ tasks.

| Greedy | Rollout Only | Mixture (λ = 0.1) | Value network only |
|---|---|---|---|
| 28.8 | 74.2 | 78.3 | 57.4 |

As discussed above with respect to FIG. 12, once the system has completed K rounds, π*_{θ}(s) can select the most visited action a for state s. The system can begin the process again at the subsequent state. The search tree can be reused for subsequent time steps for efficiency (e.g., using K−n(s, a) additional rounds for the subsequent state).

Trajectories can be sampled with π*_{θ}, and θ can be updated by training π_{θ}(s) to approximate π*_{θ}(s) for each s in the sampled trajectories. This then also improves π*_{θ}(s), as θ informs how the search space is constrained and prioritized. This facilitates iterative improvement of π_{θ}(s). To produce trajectories, MiniWob++ tasks and seeds can be randomly sampled. The system can select actions according to π*_{θ}. Trajectories where the raw reward is <0.8 can be filtered out. Parameters θ can then be tuned on these new trajectories. For simplicity, the value network (i.e. ϕ) can be fixed. We initially found that tuning on trajectories from MCTS could be unstable, leading to an early loss spike. To resolve this, decreasing the learning rate (e.g., from 1e⁻³ to 5e⁻⁴) and increasing the number of warmup steps (e.g., from 1000 to 4000) relative to the hyperparameters used for behavioral cloning can help improve stability of the tree search.

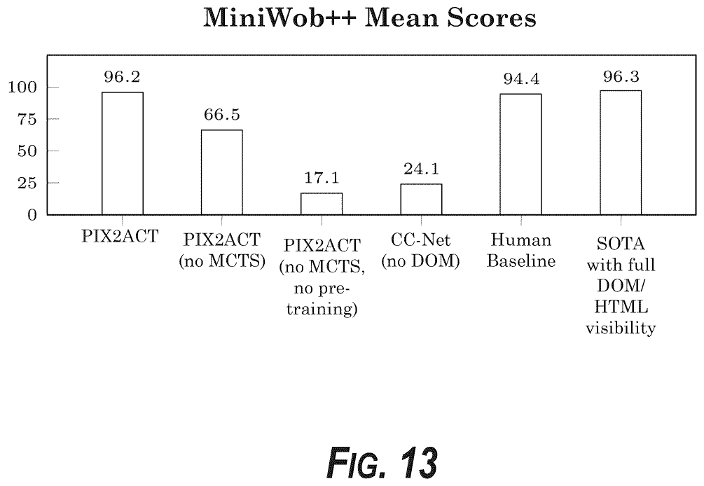

To demonstrate example technical improvements and advantages of example implementations of the present disclosure, example test results are provided herein for discussion purposes only. An example implementation of a machine-learned command generation model 102 is described in the present example to illustrate a particular configuration that was used to obtain a set of results to be compared against various baselines. It is to be understood that that particular selections of configuration options used in the present example results discussion are described here by way of example. For the sake of clarity, the test implementation used to obtain the results described in FIG. 13 will be referred to as “PIX2ACT,” shorthand that indicates that the model ingests pixel data and maps the pixel data to actions.

PIX2ACT is a fine-tuned model forked from the pre-trained PIX2STRUCT model (Lee et al., 2023), which uses an image Transformer encoder and a text Transformer decoder. The architecture is based on Vision Transformer (Dosovitskiy et al., 2021) and T5 (Raffel et al., 2020). PIX2STRUCT is pre-trained on a screenshot parsing task: predicting simplified HTMLs from screenshots with visually-masked regions. The PIX2STRUCT base variant with 282M parameters (12 encoder and 12 decoder layers; hidden size 768) was the initialization architecture for the versions of PIX2ACT used for all experiments.

PIX2ACT is called once per time step. The only input to the model is pixel-based observation from the environment. Variations were explored that can also condition on multiple previous observations by concatenating multiple frames, but such conditioning is not used for the present example results. Image pre-processing is performed by scaling input images up or down so as to extract the maximal number of fixed-size patches that still fit within the sequence length limit. PIX2ACT uses resolutions of 160×210 and 800×600 for MiniWoB++ and WebShop, respectively.

PIX2ACT encodes actions as text tokens, which are predicted autoregressively by the Transformer decoder. PIX2ACT uses beam search over tokens to output the k-best actions.

For interacting with the environment, PIX2ACT uses a standard greedy policy, selecting the highest scoring action at each step, with one modification. To help prevent PIX2ACT from getting stuck in cycles, PIX2ACT tracks which actions have been taken for a given observation and selects the highest probability action in the beam that has not previously been taken given the current observation.

PIX2ACT used beam search over tokens in the text decoder to produce a set of top-k actions for a given state, along with their approximate probabilities. They are subject to a length normalization factor of 0.6 during beam search. For MiniWob and WebShop, the experiments used k=8 and k=10, respectively.

Variants of PIX2ACT were generated with two methods for training models to follow instructions via GUIs. Variants were trained using Behavioral Cloning (BC), where PIX2ACT is trained using standard supervised learning to predict the given action for each observation in a set of human demonstrations.

Variants were trained using reinforcement learning, given access to environments with reward signals. Variants of PIX2ACT were trained with tree search for policy improvement as described herein. For a given set of model parameters, tree search leveraged the deterministic nature of the environment to look ahead at the consequences of possible actions to determine a more optimal policy than greedily selecting actions. We adopt Monte Carlo Tree Search (MCTS). Another forked model from PIX2STRUCT was trained to estimate a value function, which predicts the value (e.g., estimated future rewards) of a given state. The examples used a surrogate reward which penalizes the number of steps taken to encourage concise trajectories without unnecessary actions. The value network, instead of predicting actions, predicts state-values mapped to discrete buckets. To estimate the value of leaf states during MCTS, a combination of this value function approximator and rollouts using our greedy policy were used.

Successful episodes found with this stronger tree search policy can be used to improve the policy model. As this stronger model then yields a more effective tree search policy, the training system can continue to iteratively improve the policy model using this method. Notably, this approach requires no modifications to the fine-tuning procedure of PIX2ACT, as, for simplicity, PIX2ACT can be tuned on episodes from the tree search policy using standard supervised learning.

These experiments adapted two benchmarks, MiniWob++ and WebShop, to the environment framework which consists of pixel-based observations and generic low-level actions. These experiments also mapped previously collected human demonstrations for these benchmarks to the present observation and action spaces.

MiniWob++ (Liu et al., 2018) is a set of over a hundred web-browser based tasks. Each task includes an algorithm for generating variations of the task and an instruction template, controlled by a random seed, with up to billions of possible configurations per task. The task instruction is given as (mostly) natural language text in the top yellow part, which in the PIX2ACT framework can be accessed visually. An automatic reward is given at the end of the task.

These experiments use the human demonstrations collected by Humphreys et al. (2022). However, their demonstrations were collected using an X11-based environment, which is different from the Selenium-based environment used for the present examples. This results in different renderings of the same underlying environment state, introducing a shift between the screenshots seen during training and those observed at test time. This mapping was performed for 59 tasks.

Starting with approximately 1.3 million demonstrations across the 59 supported tasks, these experiments filtered demonstrations with a reward of <0.8, or approximately 6% of demonstrations. About 81% of the remaining demonstrations were converted to the action space used for PIX2ACT. These experiments reserved 10% of the data for a development set. Demonstrations contained approximately 3 steps per task on average, although this varies considerably across tasks.

These experiments report the mean score across seeds and tasks. The score is the MiniWob++ raw reward (without time decay) mapped from the original range [−1, 1] to the range [0, 100]. The score is equivalent to the success rate (i.e., the proportion of episodes in which the agent receives a positive reward) for tasks with binary rewards. For episodes that do not complete due to reaching a maximum number of allowed steps, these experiments assumed a score of 0. For each task, these experiments compute the mean over 100 random seeds, and then compute the mean over 59 MiniWob++ tasks.

WebShop (Yao et al., 2022) is a web-based shopping environment with over 1.1 million products from Amazon. The task is to find and purchase a product based on a human-authored text instruction. Finding a suitable product requires entering search queries, clicking on results, and determining the relevance of various products to the instruction. An automatic reward is computed based on similarity between the purchased product and the gold target product.

These experiments use the 1,566 human demonstrations (with a train/development/test split of 1012/54/500) collected in Yao et al. (2022). As with the MiniWob++ demonstrations, these experiments mapped between the observation and action sequences used in their setup to the PIX2ACT framework. Yao et al. (2022) used high-level actions (e.g. “search” or “click[item]”), each of which could map to multiple lower-level actions in the PIX2ACT environment. Specifically, for all actions involving a mouse click, these experiments determine the coordinates of the center of the corresponding HTML element. For WebShop, the entire screen content is not always visible due to page heights exceeding the viewport dimensions. If the clicked element lies outside the visible area, these experiments added scroll actions until the element is visible. Finally, these experiments map search actions to two actions in the PIX2ACT environment: clicking on the center of the search box and entering the search query followed by the enter key. HTML inputs are rendered in the human demonstrations using a browser to obtain screenshots. Rendering the last 5 actions on top of the screenshot was found to be helpful in some tests. These experiments report Task Score, which is the average reward across 500 test instructions.

During training of PIX2ACT variants, all model parameters were updated during fine-tuning, including both the image encoder and text decoder. Training used the Adafactor optimizer (Shazeer and Stern, 2018) with a learning rate of 0.01. Training on MiniWob++ finetuned a single model jointly on episodes from all tasks for a total of 26K steps using a batch size of 512, input/output sequence lengths of 512/16.

The tree search procedure was also used to refine some variants of PIX2ACT. Two iterations of policy improvement were performed with tree search, collecting a total of 826K episodes across all tasks, and tuning for a further 26K steps.

Training used only the provided human demonstrations to train PIX2ACT on WebShop. Due to its larger resolution and text-heavy data, PIX2ACT used a higher input sequence length of 4096. Testing showed that in some cases it was useful to perform intermediate finetuning on MiniWoB++, followed by 10K steps of further finetuning on WebShop using a batch size of 256.

The results of PIX2ACT models on MiniWob++ and WebShop are provided in FIG. 13. For MiniWob++, the only comparable baselines are from the CC-Net model of Humphreys et al. (2022), which mentions an ablation experiment where performance dropped by 75% from their primary results when the models conditioned on only screenshots without DOM information. As they did not provide per-task numbers for this ablation, it is estimated that the performance of CC-Net without DOM information dropped in performance on the subset of tasks studied here by the same rate, 75%.

The experiments evaluated model performance without the pre-training procedure. For these experiments, an experiment only compared performance of models trained using behavioral cloning. The results are shown in FIG. 13.

An experiment can also compare PIX2ACT results without access to DOM or HTML to previous methods that utilized these resources, including those which also leverage DOM information to construct specialized action spaces. The performance of the best model from prior work leveraging DOM or HTML information is shown in FIG. 13. PIX2ACT achieves comparable performance to the prior best model, while relying on only a subset of the information used by CC-Net, and using a comparable number of human demonstrations for training. Further experimental results are provided in Shaw et al., From Pixels to UI Actions: Learning to Follow Instructions via Graphical User Interfaces, arXiv:2306.00245v2 (Dec. 6, 2023), which is hereby incorporated by reference herein in its entirety.

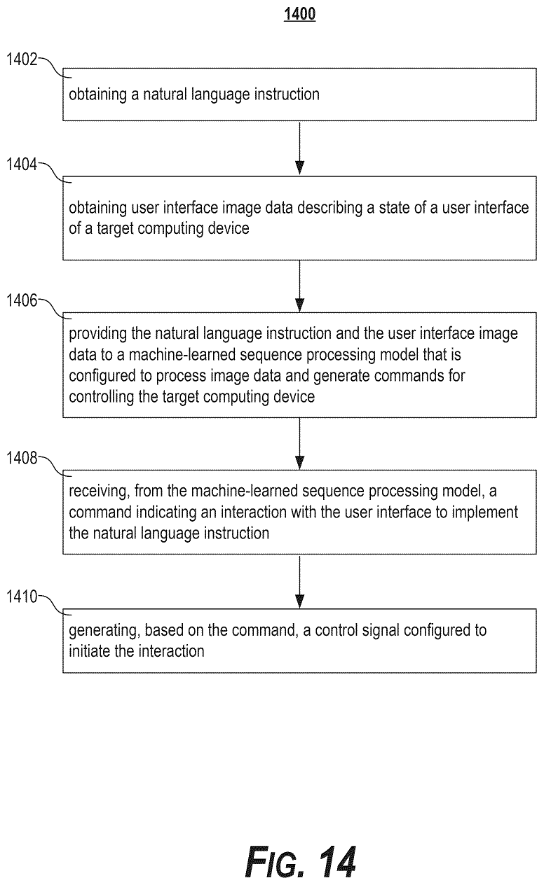

FIG. 14 depicts a flowchart of a method 1400 for performing according to aspects of the present disclosure. One or more portion(s) of example method 1400 can be implemented by a computing system that includes one or more computing devices such as, for example, computing systems described with reference to the other figures. Each respective portion of example method 1400 can be performed by any (or any combination) of one or more computing devices. Moreover, one or more portion(s) of example method 1400 can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of example method 1400 can be performed additionally, or alternatively, by other systems.

At 1402, example method 1400 can include obtaining a natural language instruction. The natural language instruction can provide a task, an operation, an action, a query, or any other form of command or request that can be executed or otherwise processed using user interface 112. The natural language instruction can be received from various user instruction sources 132 or automated instruction sources 134. The user instruction sources 132 can capture the natural language instruction in different forms, such as spoken language, text, or gestures. For instance, a user might provide the natural language instruction verbally into a microphone, and a computing system can then transcribes the spoken language into text. Alternatively, the user might type the instruction into a keyboard or touchscreen, or the instruction might be captured through a camera interpreting hand gestures. Automated instruction sources 134 can generate natural language instructions programmatically, based on predefined rules, machine learning algorithms, user inputs, or other factors. For example, a digital assistant might generate natural language instructions based on user commands or other contextual factors. A chatbot might generate instructions based on conversation flow, user inputs, or predefined scripts. Automated scripts can generate natural language instructions based on predefined rules or algorithms.

In example implementations of example method 1400, the natural language instruction is rendered into instruction image data that is combined with the user interface image data for input to the machine-learned sequence processing model.

At 1404, example method 1400 can include obtaining user interface image data describing a state of a user interface of a target computing device. Example user interface image data can be or include UI rendering 120. Example user interface image data provides a visual representation of the current state of the user interface 112. User interface image data can describe the layout, graphical elements, text, and other visual content of the user interface at a specific point in time.

The user interface image data can be obtained through various means. For instance, it could be captured as a screenshot or a video stream of the display of the target computing device. In some cases, the user interface can be rendered directly to an image file or a cache of image files (e.g., via headless rendering). The user interface image data can be a screenshot, a video stream, a 3D model, a virtual reality scene, an augmented reality overlay, or any other type of graphical representation of a user interface 112 suitable for processing by user interface command generator 100.

In the case of web-based interfaces or applications, the user interface image data can represent a rendering of a web page or a web application interface. This could include elements defined by HTML, CSS, JavaScript, or other web languages or markup schema. These elements could represent various functions and operations of the application or service, and can include elements like buttons, icons, menus, dialogue boxes, sliders, forms, text boxes, images, videos, and other graphical elements.

At 1406, example method 1400 can include providing the natural language instruction and the user interface image data to a machine-learned sequence processing model that is configured to process image data and generate commands for controlling the target computing device. An example machine-learned sequence processing model can be machine-learned command generation model 102. Control of the target computing device can be direct or indirect. Control can generally involve initiating an action that is configured to cause a response of the target computing device, such as by emitting a command that is configured to cause a response of the target computing device.

In example implementations of example method 1400, the machine-learned sequence processing model can include parameters that were learned using an interface recognition objective based on an evaluation of an interface recognition output generated based on processing a rendered training interface from a pre-training dataset. For instance, machine-learned command generation model 102 can include parameters that were learned using an interface recognition objective based on an evaluation of an interface recognition output generated based on processing a rendered training interface from a pre-training dataset. For example, before being fine-tuned for generating commands, the model can be pre-trained on a task of interface recognition. In the interface recognition task, the model can learn to recognize and understand the structure and content of user interfaces based on image data. The pre-training dataset can include numerous examples of rendered training interfaces, each representing a different state of a user interface. These interfaces can be rendered into image data that the model processes to generate an interface recognition output. The interface recognition objective can compare the model's interface recognition output with a ground truth reference point (e.g., an actual interface description, label, structure, etc.), generating a measure of the difference or error between the model's output and the actual interface structure. This difference can serve as a learning signal used to update the parameters of the model, causing the model to improve its recognition performance. This pre-training phase can help the model to learn an essential understanding of user interfaces, including the layout, elements, states of elements, and relationships between elements, purely based on their graphical representations. Such knowledge can provide a strong foundation for the model to infer actions to be taken based on the current state of the user interface.

In example implementations of example method 1400, the machine-learned sequence processing model can include parameters that were learned using an interface navigation objective based on an evaluation of a user interface command generated based on processing a rendered training interface from a fine-tuning dataset. For instance, during an example fine-tuning phase, machine-learned command generation model 102 can be trained to generate control commands based on user interface image data and a natural language instruction. This training process can be guided by an interface navigation objective that evaluates user interface commands generated by the model in response to specific tasks described by natural language instructions. The fine-tuning dataset can include various examples of rendered training interfaces, each associated with a specific navigation task. Each training interface can represent a different state of a user interface, such as a different screen of an application, a different stage of a task, a different layout or design, or any other state of the user interface. These interfaces can be rendered into image data, and along with a natural language instruction describing the navigation task, can be processed by the model to generate a user interface command. The interface navigation objective can compare the generated user interface command with a ground truth command provided in the fine-tuning dataset. This comparison can produce a measure of the difference or error between the model's output and the ground truth. This measure can be used as a learning signal to update the parameters of the model. The model can be trained using various learning algorithms to minimize this error, effectively tailoring the pre-trained model to the specific task of generating user interface commands.

In example implementations of example method 1400, the machine-learned sequence processing model is unimodal. For instance, machine-learned command generation model 102 can process image data only. Natural language instructions can be rendered into image data and processed alongside UI rendering 120.

In example implementations of example method 1400, the machine-learned sequence processing model comprises parameters that were learned using a text recognition objective based on an evaluation of textual content recovered from an image of a text snippet. For instance, machine-learned command generation model 102 can be pre-trained to output text that is contained in an input image.

In example implementations of example method 1400, the machine-learned sequence processing model comprises parameters that were learned by training an initialized machine-learned sequence processing model using the text recognition objective to obtain a first model checkpoint. The first model checkpoint can be a first saved state of model parameters of one or more portions of machine-learned command generation model 102. In example implementations of example method 1400, the machine-learned sequence processing model comprises parameters that were learned by training the first model checkpoint using the interface recognition objective to obtain a second model checkpoint. For instance, the first model checkpoint can provide an initial state of parameters that can then be updated using the interface recognition objective over one or more iterations. The resulting updated model parameters can be saved as a second model checkpoint. In example implementations of example method 1400, the machine-learned sequence processing model comprises parameters that were learned by training the second model checkpoint using the interface navigation objective to obtain a third model checkpoint.

In example implementations of example method 1400, the machine-learned sequence processing model comprises an image encoder and a text decoder. For example, in example implementations of example method 1400, the machine-learned sequence processing model comprises a natural language encoder that processes a textual input to encode the natural language instruction into a first latent representation. In example implementations of example method 1400, the machine-learned sequence processing model comprises an image encoder that processes the user interface image data to encode the user interface image data into a second latent representation. In example implementations of example method 1400, the machine-learned sequence processing model comprises a text decoder that processes the first latent representation and the second latent representation to generate commands. In example implementations of example method 1400, the text decoder is configured with a natural language output vocabulary.

At 1408, example method 1400 can include receiving, from the machine-learned sequence processing model, a command indicating an interaction with the user interface to implement the natural language instruction. Example commands can be control commands 140. Example commands can indicate system-level UI interactions. In example implementations of example method 1400, the command comprises at least a selection command, a cursor movement command, a keypress command, or a scroll command. In example implementations of example method 1400, the command comprises an input to an application programming interface that invokes an operation of an application operating on the target computing device.

At 1410, example method 1400 can include generating, based on the command, a control signal configured to initiate the interaction. In example implementations of example method 1400, generating the control signal comprises inputting the command to an interpreter, wherein the interpreter receives the command and executes a control script to implement the command. In example implementations of example method 1400, the interpreter maps commands to control functions associated with an operating environment of the target computing device. In example implementations of example method 1400, the interpreter comprises a machine-learned classifier that processes the commands and identifies the control functions that are predicted to correspond to the commands. In example implementations of example method 1400, the interpreter comprises deterministic logic that processes the commands and identifies the control functions that are defined to correspond to the commands.

In example implementations of example method 1400, a computing system implementing the example method 1400 includes a controller computing device that comprises the one or more processors and the one or more non-transitory computer-readable media.

In example implementations of example method 1400, a computing system implementing the example method 1400 includes the target computing device.

In example implementations of example method 1400, a computing system implementing the example method 1400 can include one or more non-transitory computer-readable media that store a client application and an application programming interface (API). The API can be configured to receive input image data and input natural language instruction data describing an action to perform using an user interface described by the input image data. The API can be configured to return an output command for execution by the computing system to interact with the user interface described by the input image data. The one or more non-transitory computer-readable media can store the machine-learned sequence processing model. The machine-learned sequence processing model can be configured to process image data received via the API and generate commands for output via the API. In example implementations of example method 1400, example method 1400 can include inputting, to the API, image data, and receiving, from the API, the command.

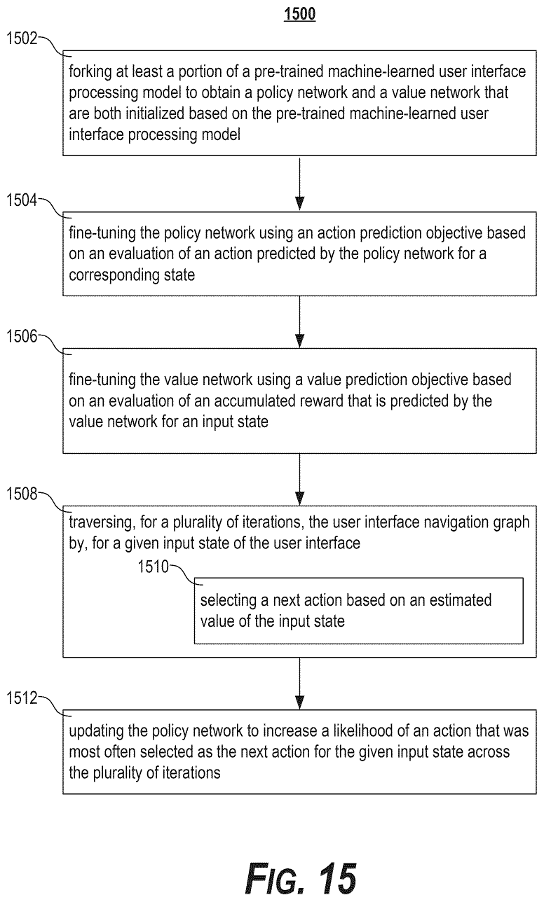

FIG. 15 depicts a flowchart of a method 1500 for performing according to aspects of the present disclosure. One or more portion(s) of example method 1500 can be implemented by a computing system that includes one or more computing devices such as, for example, computing systems described with reference to the other figures. Each respective portion of example method 1500 can be performed by any (or any combination) of one or more computing devices. Moreover, one or more portion(s) of example method 1500 can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of example method 1500 can be performed additionally, or alternatively, by other systems.

At 1502, example method 1500 can include forking at least a portion of a pre-trained machine-learned user interface processing model (e.g., pre-trained machine-learned user interface processing model 1000) to obtain a policy network and a value network that are both initialized based on the pre-trained machine-learned user interface processing model. For instance, an encoder portion can be forked from the pre-trained machine-learned user interface processing model to provide a pre-trained initialization for each of the policy network and the value network. A decoder portion can be newly initialized or constructed for each of the policy network and the value network. In some implementations, the entire pre-trained machine-learned user interface processing model can be forked such that each of the policy network and the value network share the architecture and initial parameter values of the pre-trained machine-learned user interface processing model.

At 1504, example method 1500 can include fine-tuning the policy network using an action prediction objective based on an evaluation of an action predicted by the policy network for a corresponding state. For example, an action prediction objective can be a policy objective 1012. An action prediction objective can be an objective used to train machine-learned command generation model 102, such as an interface navigation objective based on an evaluation of a user interface command generated based on processing a rendered training interface from a fine-tuning dataset. In some implementations of example method 1500, fine-tuning the policy network comprises fine-tuning a policy fork of a text decoder of the pre-trained machine-learned user interface processing model to generate textual commands.

At 1506, example method 1500 can include fine-tuning the value network using a value prediction objective based on an evaluation of an accumulated reward that is predicted by the value network for an input state. For example, a value prediction objective can be value prediction objective 1022. Value prediction objective 1022 can include an evaluation of the predicted value or reward and an actual or measured value or reward flowing from a given state or selection of an action. For instance, a dataset can be labeled with reward values at different states of a user interface. These reward values can supervise the predictions of value network 1010 during fine-tuning. The predictions of value network 1010 can be trained on a per-state basis, or value network 1010 can be trained to directly generate a cumulative value for traversing multiple states toward a goal state of the user interface.

In some implementations of example method 1500, fine-tuning the value network comprises fine-tuning a value fork of the text decoder of the pre-trained machine-learned user interface processing model to output textual value indicators.

At 1508, example method 1500 can include traversing, for a plurality of iterations, the user interface navigation graph. A user interface navigation graph can represent different states of a user interface. A state of the user interface can be represented in a node. Actions that cause one state to follow another can be represented as edges of the graph. For example, a first state of a user interface can include a rendering of the interface having a button with a down arrow signaling the presence of a dropdown menu. This first state can be stored in association with a first node. An action can include a click on coordinates associated with the button. This action can be stored in association with an edge emanating from the first node. The edge can connect the first node to a second node. A second state of the user interface can be stored in association with the second node. The second state of the user interface can include a rendering of the dropdown menu being open and displaying its contents.

In this manner, for instance, the user interface navigation graph can be traversed by, for a given input state of the user interface, selecting a next action to be performed based on the input state. In some implementations of example method 1500, the next action can be selected based on an estimated value of the input state. The estimated value can include a first component predicted by the value network (e.g., predicted reward 1120) and a second component indicating a measured accumulated reward obtained based on one or more rollouts using the policy network to select actions at the given input state and one or more subsequent states (e.g., measured reward 1112).

At 1510, example method 1500 can include updating (e.g., training) the policy network to increase a likelihood of an action that was most often selected as the next action for the given input state across the plurality of iterations.

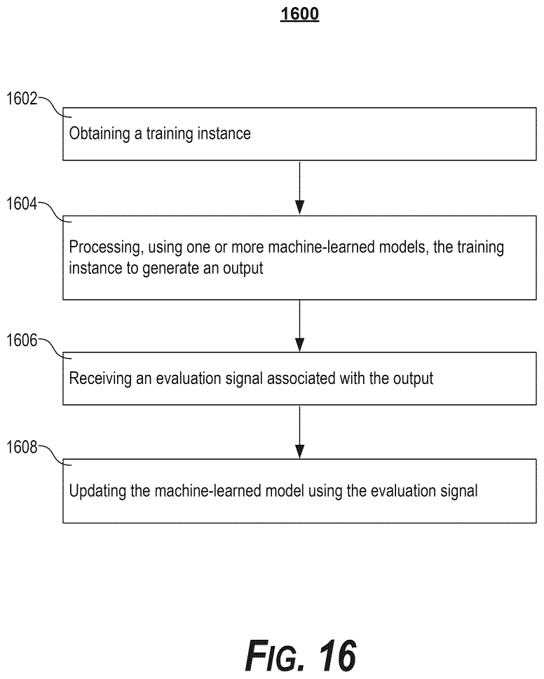

FIG. 16 depicts a flowchart of a method 1600 for training one or more machine-learned models according to aspects of the present disclosure. For instance, an example machine-learned model can include a model used in user interface command generator 100, such as machine-learned command generation model 102, policy network 1010, value network 1020, etc.

One or more portion(s) of example method 1600 can be implemented by a computing system that includes one or more computing devices such as, for example, computing systems described with reference to the other figures. Each respective portion of example method 1600 can be performed by any (or any combination) of one or more computing devices. Moreover, one or more portion(s) of example method 1600 can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of example method 1600 can be performed additionally, or alternatively, by other systems.

At 1602, example method 1600 can include obtaining a training instance. A set of training data can include a plurality of training instances divided between multiple datasets (e.g., a training dataset, a validation dataset, or testing dataset). A training instance can be labeled or unlabeled. Although referred to in example method 1600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1604, example method 1600 can include processing, using one or more machine-learned models, the training instance to generate an output. The output can be directly obtained from the one or more machine-learned models or can be a downstream result of a chain of processing operations that includes an output of the one or more machine-learned models.

At 1606, example method 1600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1608, example method 1600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1600 can include implementing a number of generalization techniques (e.g., weight decays, dropouts, etc.) to improve the generalization capability of the models being trained.

In some implementations, example method 1600 can be implemented for training a machine-learned model from an initialized state to a fully trained state (e.g., when the model exhibits a desired performance profile, such as based on accuracy, precision, recall, etc.).

In some implementations, example method 1600 can be implemented for particular stages of a training procedure. For instance, in some implementations, example method 1600 can be implemented for pre-training a machine-learned model. Pre-training can include, for instance, large-scale training over potentially noisy data to achieve a broad base of performance levels across a variety of tasks/data types. In some implementations, example method 1600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

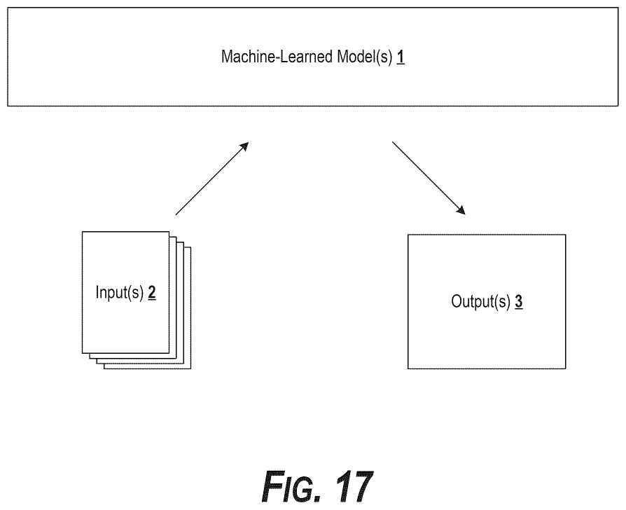

FIG. 17 is a block diagram of an example processing flow for using machine-learned model(s) 1 to process input(s) 2 to generate output(s) 3.

Machine-learned model(s) 1 can be or include any one of or any part of machine-learned models referenced with respect to user interface command generator 100. For example, any one or multiple of machine-learned command generation model 102, interpreter 142, input preprocessor 200, image encoder 302, text encoder 304, a text decoder, pre-trained machine-learned model 1000, policy network 1010, value network 1020, search policy, etc. can be, includer, or be implemented using any variant of machine-learned model 1. Any model or learned component of the systems described herein can be or include a machine-learned model 1. Features and variations described herein with respect to machine-learned model 1 are to be understood as describing features and variations of any of the machine-learned models and components described herein. Where this description references machine-learned model 1 it is to be understood that implementations of each of the other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

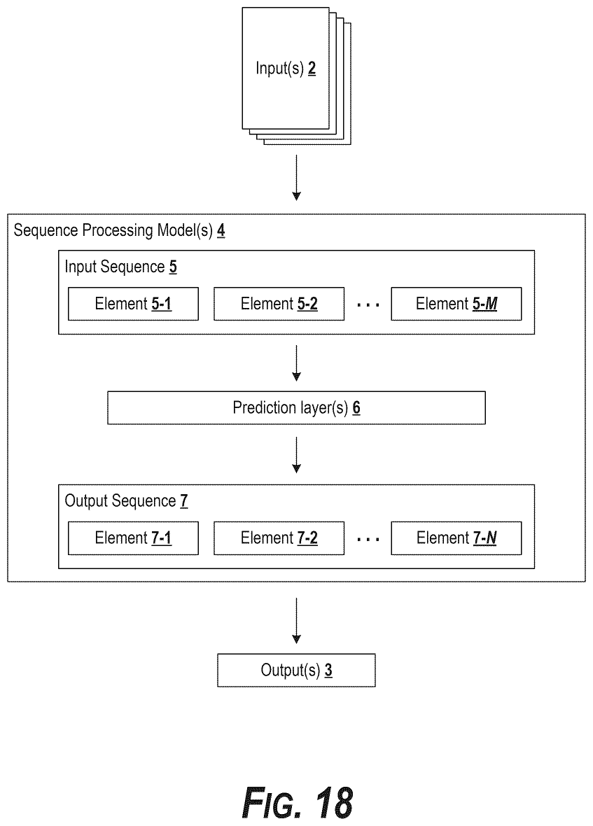

FIG. 18 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIv:2010.11929v2 (Jun. 3, 2021), audio domains, see, e.g., Agostinelli et al., MusicLM: GeneratingMusic From Text, ARXIv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 18 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

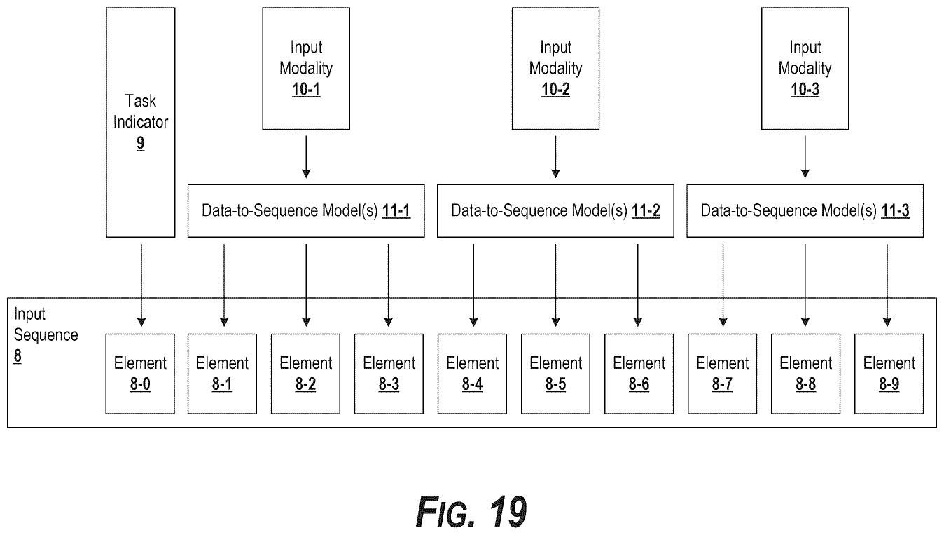

FIG. 19 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

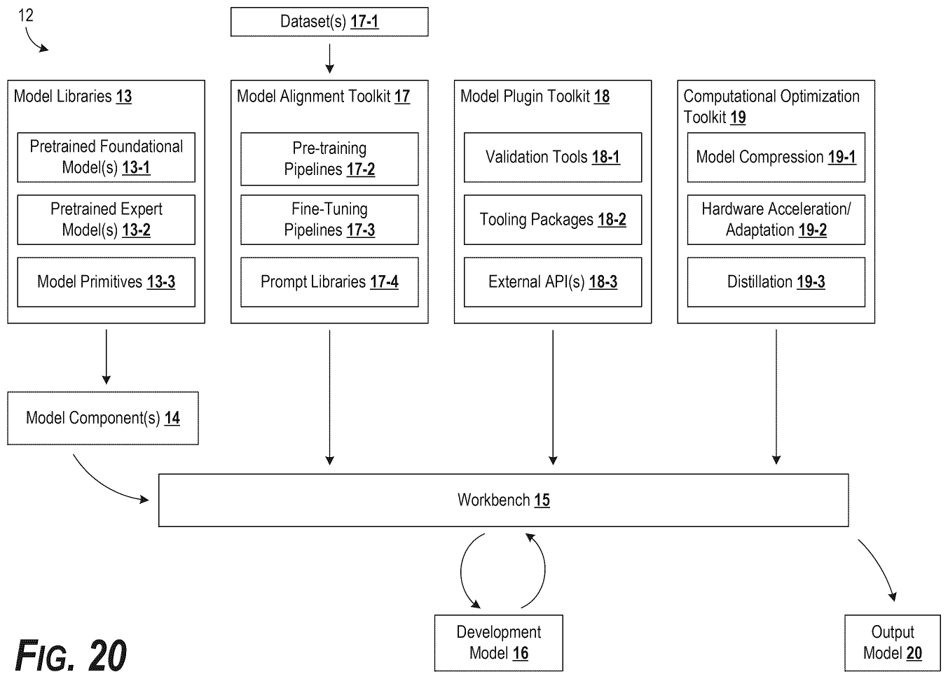

FIG. 20 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

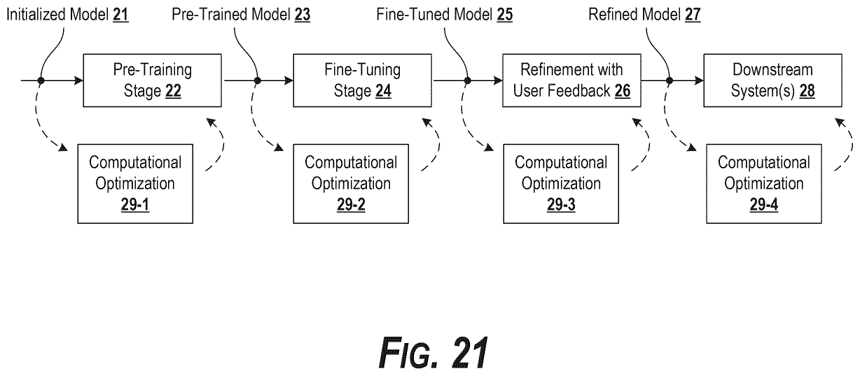

FIG. 21 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 21 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 21 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

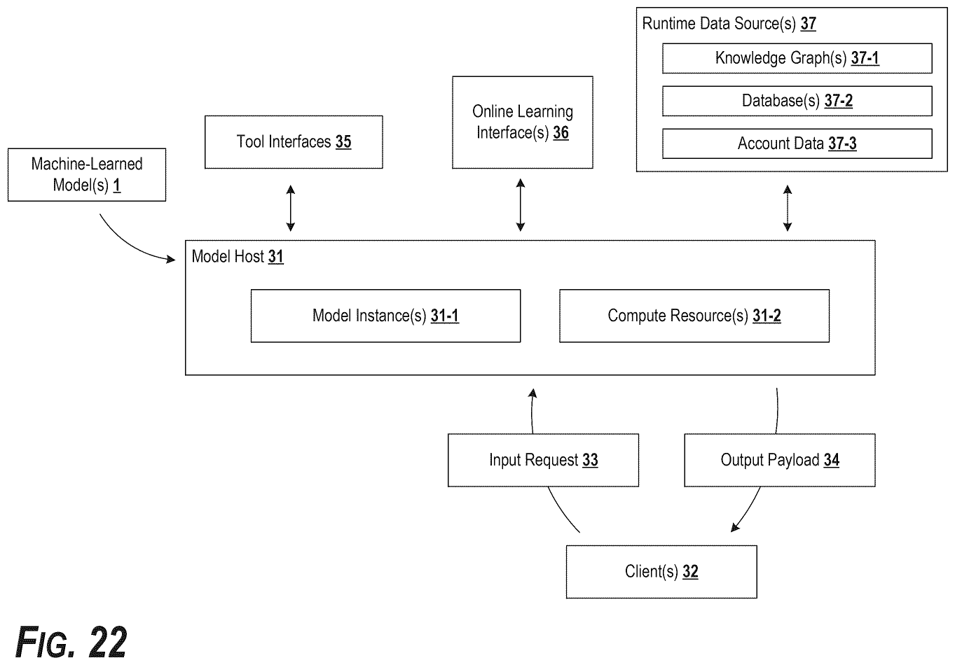

FIG. 22 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

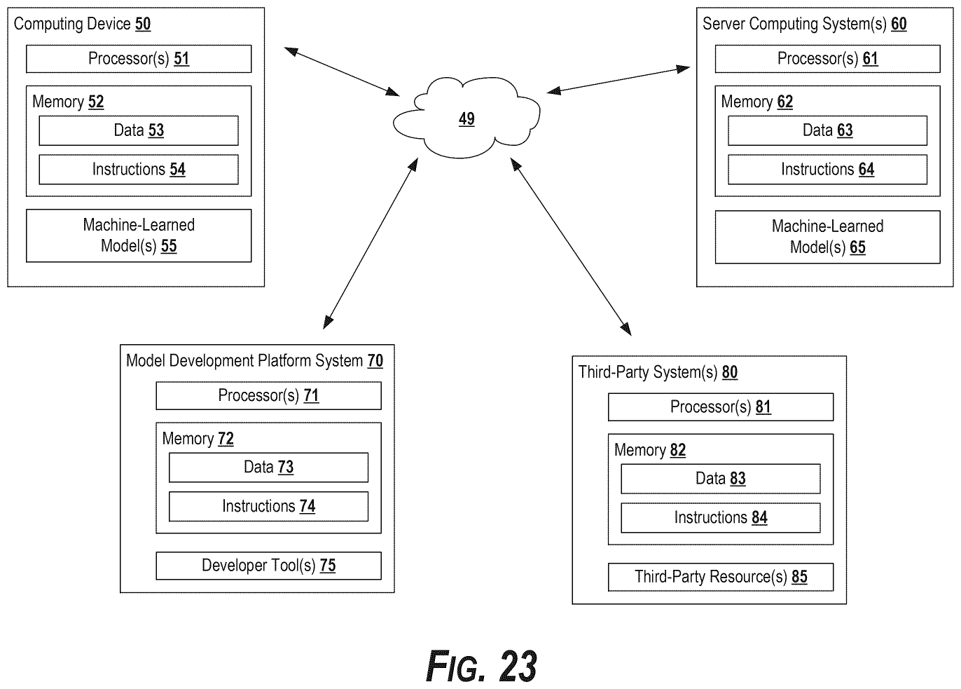

FIG. 23 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 23 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or intraoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 23 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

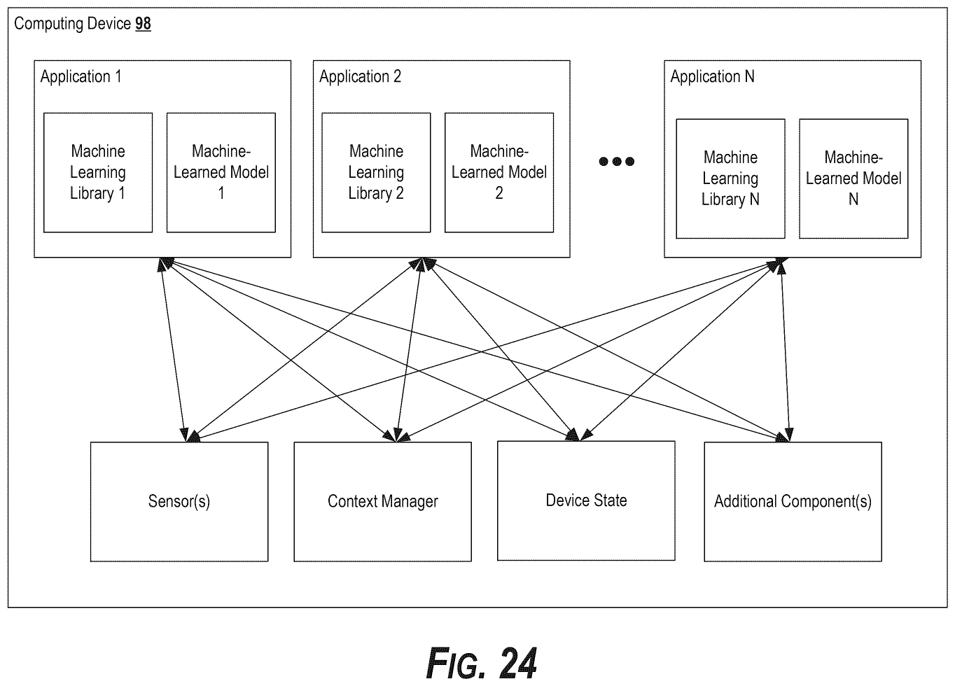

FIG. 24 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 24, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

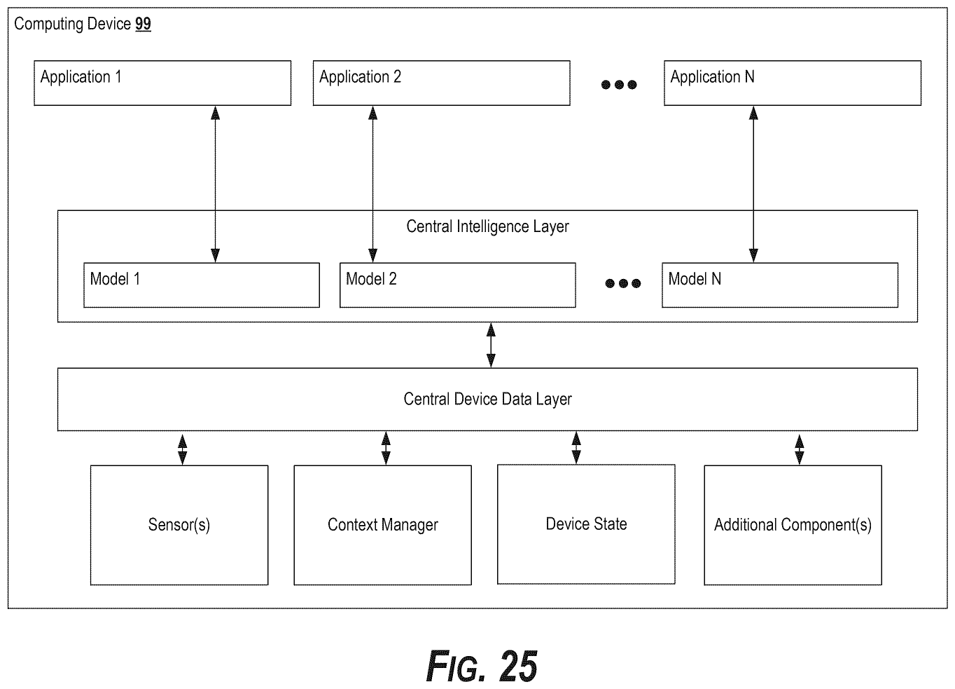

FIG. 25 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 25, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 25, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system, comprising:
one or more processors; and
one or more non-transitory computer-readable media storing instructions that are executable by the one or more processors to cause the computing system to perform operations, the operations comprising:
obtaining a natural language instruction;
obtaining user interface image data describing a state of a user interface of a target computing device;
providing the natural language instruction and the user interface image data to a machine-learned sequence processing model that is configured to process image data and generate commands for controlling the target computing device, wherein the machine-learned sequence processing model comprises parameters that were learned using:
an interface recognition objective based on an evaluation of an interface recognition output generated based on processing a rendered training interface from a pre-training dataset; and
an interface navigation objective based on an evaluation of a user interface command generated based on processing a rendered training interface from a fine-tuning dataset;
receiving, from the machine-learned sequence processing model, a command indicating an interaction with the user interface to implement the natural language instruction; and
generating, based on the command, a control signal configured to initiate the interaction.

2. The computing system of claim 1, wherein the natural language instruction is rendered into instruction image data that is combined with the user interface image data for input to the machine-learned sequence processing model.

3. The computing system of claim 1, wherein the machine-learned sequence processing model is unimodal.

4. The computing system of claim 1, wherein the machine-learned sequence processing model comprises parameters that were learned using:
a text recognition objective based on an evaluation of textual content recovered from an image of a text snippet.

5. The computing system of claim 4, wherein the machine-learned sequence processing model comprises parameters that were learned by:
training an initialized machine-learned sequence processing model using the text recognition objective to obtain a first model checkpoint;
training the first model checkpoint using the interface recognition objective to obtain a second model checkpoint; and
training the second model checkpoint using the interface navigation objective to obtain a third model checkpoint.

6. The computing system of claim 1, wherein the machine-learned sequence processing model comprises an image encoder and a text decoder.

7. The computing system of claim 1, wherein the machine-learned sequence processing model comprises:
a natural language encoder that processes a textual input to encode the natural language instruction into a first latent representation;
an image encoder that processes the user interface image data to encode the user interface image data into a second latent representation; and
a text decoder that processes the first latent representation and the second latent representation to generate commands.

8. The computing system of claim 6, wherein the text decoder is configured with a natural language output vocabulary.

9. The computing system of claim 1, wherein generating the control signal comprises:
inputting the command to an interpreter, wherein the interpreter receives the command and executes a control script to implement the command.

10. The computing system of claim 9, wherein the interpreter maps commands to control functions associated with an operating environment of the target computing device.

11. The computing system of claim 10, wherein the interpreter comprises a machine-learned classifier that processes the commands and identifies the control functions that are predicted to correspond to the commands.

12. The computing system of claim 10, wherein the interpreter comprises deterministic logic that processes the commands and identifies the control functions that are defined to correspond to the commands.

13. The computing system of claim 1, wherein the command comprises at least:
a selection command;
a cursor movement command;
a keypress command; or
a scroll command.

14. The computing system of claim 1, wherein the command comprises an input to an application programming interface that invokes an operation of an application operating on the target computing device.

15. The computing system of claim 1, comprising:
a controller computing device that comprises the one or more processors and the one or more non-transitory computer-readable media.

16. The computing system of claim 1, comprising:
the target computing device, wherein the target computing device comprises the one or more processors and the one or more non-transitory computer-readable media.

17. The computing system of claim 1, wherein:
the one or more non-transitory computer-readable media store:
a client application;
an application programming interface (API) configured to:
receive input image data and input natural language instruction data describing an action to perform using an user interface described by the input image data; and
return an output command for execution by the computing system to interact with the user interface described by the input image data; and
the machine-learned sequence processing model, wherein the machine-learned sequence processing model is configured to process image data received via the API and generate commands for output via the API; and
the operations comprise:
inputting, to the API, image data; and
receiving, from the API, the command.

18. One or more non-transitory computer-readable media storing instructions that are executable by one or more processors to cause a computing system to perform operations, the operations comprising:
obtaining a natural language instruction;
obtaining user interface image data describing a state of a user interface of a target computing device;
providing the natural language instruction and the user interface image data to a machine-learned sequence processing model that is configured to process image data and generate commands for controlling the target computing device, wherein the machine-learned sequence processing model comprises parameters that were learned using:
an interface recognition objective based on an evaluation of an interface recognition output generated based on processing a rendered training interface from a pre-training dataset; and
an interface navigation objective based on an evaluation of a user interface command generated based on processing a rendered training interface from a fine-tuning dataset;
receiving, from the machine-learned sequence processing model, a command indicating an interaction with the user interface to implement the natural language instruction; and
generating, based on the command, a control signal configured to initiate the interaction.

19. A method for training a machine-learned sequence processing model to predict actions that traverse one or more states in a user interface navigation graph for a user interface, the method comprising:
forking at least a portion of a pre-trained machine-learned user interface processing model to obtain a policy network and a value network that are both initialized based on the pre-trained machine-learned user interface processing model;
fine-tuning the policy network using an action prediction objective based on an evaluation of an action predicted by the policy network for a corresponding state;
fine-tuning the value network using a value prediction objective based on an evaluation of an accumulated reward that is predicted by the value network for an input state;
traversing, for a plurality of iterations, the user interface navigation graph by, for a given input state of the user interface;
selecting a next action based on an estimated value of the input state, wherein the estimated value comprises a first component predicted by the value network and a second component comprising a measured accumulated reward obtained based on one or more rollouts using the policy network to select actions at the given input state and one or more subsequent states; and
updating the policy network to increase a likelihood of an action that was most often selected as the next action for the given input state across the plurality of iterations.

20. The method of claim 19, wherein:
fine-tuning the policy network comprises fine-tuning a policy fork of a text decoder of the pre-trained machine-learned user interface processing model to generate textual commands; and
fine-tuning the value network comprises fine-tuning a value fork of the text decoder of the pre-trained machine-learned user interface processing model to output textual value indicators.
